(19) United States
(12) Patent Application Publication
(10) Pub. No.: US 2009/0203424 A1
(43) Pub. Date: Aug. 13, 2009

(54) Slot Machine Offering a Special Payout and Control Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/345,006

(22) Filed: Dec. 29, 2008

Related U.S. Application Data
(60) Provisional application No. 61/027,641, filed on Feb. 11, 2008.

(51) Int. Cl. A63F 9/24; A63F 13/00

(52) U.S. Cl. 463/20; 463/31

(57) ABSTRACT

A slot machine comprising: a display capable of rearranging normal symbols and a multiplying-factor symbol corresponding to a number; and a controller programmed to execute processing of: (A) rearranging the normal symbols the multiplying-factor symbol to the display in such a manner that the multiplying-factor symbol is rearranged at a timing of a first or last rearrangement in rearrangements, when the multiplying-factor symbol is rearranged to the display; (B-1) determining a normal payout amount, based on the numbers of the normal symbols of respective types rearranged in the processing (A); and (C-1) paying out game media in amount obtained by multiplying the normal payout amount determined in the processing (B-1) by the number corresponding to the multiplying-factor symbol rearranged in the processing (A).

### BACKGROUND OF THE INVENTION

1. Field of the Invention

The present invention relates to a slot machine offering a special payout and a method for controlling the same.

2. Discussion of the Background

In conventional slot machines, when a player inserts game media such as medals, coins or bills into an insertion slot of the slot machine and presses a spin button, then a plurality of symbols are scroll-displayed to a display portion provided on the front surface of a casing and, thereafter, the respective symbols are automatically stopped, as disclosed in U.S. Pat. Nos. 6,960,133, 6,012,983 and 6,093,102. In this case, when scroll-display of respective symbols starts by an input from the spin button, symbols are selected using random numbers, and the selected symbols are stop-displayed to the display portion. Then, when a combination of the stop-displayed symbols along a winning line is a predetermined winning combination (prize), a payout is conducted.

Further, among conventional slot machines, there are some slot machines which conduct two types of payouts which are a payout determined according to the combinations of symbols rearranged along winning lines and a payout determined according to the number of displayed scatter symbols, as disclosed in U.S. Pat. No. 6,604,999 and US 2002-0065124-A1. In such a slot machine which conducts payouts based on such scatter symbols, there is no relationship between payouts and positions at which the scatter symbols are displayed.

Generally, in the above-mentioned conventional slot machines, in the case where plural types of predetermined prizes are established, game media in amount corresponding to the total sum of amounts of respective payouts determined for the respective prizes are paid out to the player. That is, although plural types of prizes are established, an amount of a payout to be offered to the player is only an amount obtained by simple addition of amounts of payouts determined based on the respective prizes.

Thus, although plural types of prizes are established, the amount of game media to be offered to the player is only the total sum of the amounts of game media to be offered when each prize is established independently, so that lack of significant increase in amounts of payouts causes a problem that the player possibly loses a sense of expectation for the payouts.

Moreover, in the conventional slot machines, symbols to be displayed (for example, a symbol “watermelon”) are used as a component factor of a predetermined prize (for example, rearrangement of three “watermelons”), and are not symbols that increase an amount of a payout determined based on a prize upon establishment of the prize (for example, symbol that increases an amount of a payout based on the prize of three “watermelons” 3-fold). Therefore, the player has interests only in symbols that can be a component factor of the predetermined prize, resulting in a tendency of the player to get bored.

In light of the aforementioned problems, the present invention has been devised, and an object of the present invention is to provide a slot machine and a game control method which enable preventing the player from losing a sense of expectation for payouts and avoid a tendency of the player to get bored.

### SUMMARY OF THE INVENTION

The present invention provides a slot machine having the following configuration.

That is, the slot machine comprises a display and a controller. The display is capable of rearranging normal symbols and a multiplying-factor symbol corresponding to a number. The controller is programmed to execute processing of: (A) rearranging the normal symbols and the multiplying-factor symbol to the display in such a manner that the multiplying-factor symbol is rearranged at a timing of a first or last rearrangement in rearrangements, when the multiplying-factor symbol is rearranged to the display; (B-1) determining a normal payout amount, based on the numbers of the normal symbols of respective types rearranged in the processing (A); and (C-1) paying out game media in amount obtained by multiplying the normal payout amount determined in the processing (B-1) by the number corresponding to the multiplying-factor symbol rearranged in the processing (A).

According to the aforementioned slot machine, the multiplying-factor symbol may be rearranged to the display. Further, each of the multiplying-factor symbols corresponds to a number. The rearrangement of the multiplying-factor symbol to the display causes paying out of game media in amount obtained by multiplying the normal payout by the number corresponding to the multiplying-factor symbol.

As described above, according to the aforementioned slot machine, in the case of rearrangement of the multiplying-factor symbol, a player can acquire several times larger amount of game media, resulting in enhancement of a sense of expectancy of the player for payouts. Therefore, it is possible to prevent the player from losing a sense of expectancy for payouts.

Further, since the multiplying-factor symbol capable of increasing several-fold an amount of game media that the player can acquire may be rearranged, it is possible to lead the player to have interests and concern for the rearrangement of the multiplying-factor symbol. Furthermore, since the player plays games with a great sense of expectancy for the rearrangement of the multiplying-factor symbol, it is possible to prevent the player from getting bored with games soon.

Further, according to the aforementioned slot machine, the multiplying-factor symbol is rearranged at the timing of the first rearrangement or the last rearrangement. That is, symbols are rearranged in either one of the following patterns: a pattern in which the multiplying-factor symbol is rearranged after rearranging the normal symbols; and a pattern in which the normal symbols are rearranged after rearranging the multiplying-factor symbol.

In the case where the symbols are rearranged in the pattern in which the multiplying-factor symbol is rearranged after rearranging the normal symbols, the multiplying-factor symbol will be rearranged after the player roughly recognizes the normal payout amount determined by the result of the rearrangement of the normal symbols. For example, when the player finds that the rearranged normal symbols results in a prize that offers a relatively large amount of a payout, the player waits for the rearrangement of the multiplying-factor symbol with expectation for a further increase in the amount of the payout. On the contrary, when the player finds that the rearranged normal symbols results in no payout, since the rearrangement of the multiplying-factor symbol only results in no increase in an amount of a payout, the player does not expect the rearrangement of the multiplying-factor symbol. In this way, this configuration allows the player to have emotional ups or downs depending on rearranged normal symbols, resulting in further enhancement of entertainment of the games. As a result, it is possible to offer a game that possibly avoids a tendency of the player to get bored for a long period of time.

On the other hand, in the case where the symbols are rearranged in the pattern in which the normal symbols are rearranged after rearranging the multiplying-factor symbol, the normal symbols will be rearranged after the player recognizes the multiplying-factor indicated by the multiplying-factor symbol. For example, when a multiplying-factor symbol indicative of a large number is rearranged followed by the rearrangement of normal symbols that results in a prize offering a large amount of a payout, the player can acquire a significantly large number of game media, resulting in significant enhancement of a sense of expectancy of the player for payouts. Therefore, it is possible to prevent the player from losing a sense of expectancy for payouts.

Further, the slot machine of the present invention preferably has the following configuration.

That is, the controller is further programmed to execute processing of: (D) determining either one of the first rearrangement or the last rearrangement as the timing of the rearrangement of the multiplying-factor symbol in the processing (A). The processing (A) is processing for rearranging the multiplying-factor symbol to the display at the timing determined in the processing (D).

As described above, according to the aforementioned slot machine, either one of patterns is determined as the timing of the rearrangement of the multiplying-factor symbol, out of the following patterns: a pattern in which the multiplying-factor symbol is rearranged after rearranging the normal symbols; and a pattern in which the normal symbols are rearranged after rearranging the multiplying-factor symbol. Accordingly, for example, this configuration allows the player to change the pattern of the rearrangement of the multiplying-factor symbol, depending on the game state or as he/she likes. Therefore, compared to a configuration in which the multiplying-factor symbol is always rearranged at the timing of the first rearrangement or in which the multiplying-factor symbol is always rearranged at the timing of the last rearrangement, this configuration can offer a game that possibly avoids a tendency of the player to get bored.

Further, the slot machine of the present invention preferably has the following configuration.

That is, the controller is further programmed to execute processing of: (E) determining types of normal symbols to be rearranged to the display, before the processing (A). The processing (D) is processing for determining either one of the first rearrangement or the last rearrangement as the timing of the rearrangement of the multiplying-factor symbol in the processing (A), based on the types of the normal symbols determined in the processing (E).

As described above, according to the aforementioned slot machine, based on the types of the normal symbols determined to be rearranged, either one of patterns is determined as the timing of the rearrangement of the multiplying-factor symbol, out of the following patterns: a pattern in which the multiplying-factor symbol is rearranged after rearranging the normal symbols; and a pattern in which the normal symbols are rearranged after rearranging the multiplying-factor symbol. Therefore, for example, when the multiplying symbol is rearranged at the timing of the first rearrangement, the player is allowed to predict types of normal symbols to be rearranged afterward. In this way, such an action as predicting types of normal symbols to be rearranged allows the player to enjoy the games well.

Further, the slot machine of the present invention preferably has the following configuration.

That is, the controller is further programmed to execute processing of: (F) determining the numbers of the normal symbols of the respective types to be rearranged to the display, before the processing (A). The processing (D) is processing for determining either one of the first rearrangement or the last rearrangement as the timing of the rearrangement of the multiplying-factor symbol in the processing (A), based on the numbers of the normal symbols of the respective types determined in the processing (F).

As described above, according to the aforementioned slot machine, based on the numbers of the normal symbols of the respective types determined to be rearranged, either one of patterns is determined as the timing of the rearrangement of the multiplying-factor symbol, out of the following patterns: a pattern in which the multiplying-factor symbol is rearranged after rearranging the normal symbols; and a pattern in which the normal symbols are rearranged after rearranging the multiplying-factor symbol. The normal payout amount is determined based on the numbers of the normal symbols of the respective types determined to be rearranged.

Therefore, the pattern of the rearrangement is determined according to the normal payout amount. For example, when the normal payout amount is relatively smaller and the multiplying-factor symbol is rearranged at the timing of the last rearrangement, the last rearrangement of a multiplying-factor symbol having a large multiplying factor set therefor pleases the player who is disappointed with establishment of only a prize that offers a small amount of a payout. Further, for example, when the normal payout amount is relatively lager and the multiplying-factor symbol is rearranged at the timing of the last rearrangement, the multiplying-factor symbol will be rearranged after the player recognizes establishment of a prize that offers a large amount of a payout. Therefore, it is possible to lead the player to have a sense of expectancy for further increase in the amount of the payout.

Further, the slot machine of the present invention preferably has the following configuration.

That is, the slot machine comprises an input device enabling a player to input commands associated with games. The controller is further programmed to execute processing of: (G) accepting from the input device an input of selection of either one of the first rearrangement or the last rearrangement as the timing of the rearrangement of the multiplying-factor symbol in the processing (A). The processing (D) is processing for determining either one of the first rearrangement or the last rearrangement as the timing of the rearrangement of the multiplying-factor symbol in the processing (A), based on the input inputted through the input device in the processing (G)

As described above, according to the aforementioned slot machine, either one of patterns is determined by the player's selection as the timing of the rearrangement of the multiplying-factor symbol, out of the following patterns: a pattern in which the multiplying-factor symbol is rearranged after rearranging the normal symbols; and a pattern in which the normal symbols are rearranged after rearranging the multiplying-factor symbol. Accordingly, this configuration allows the player to set the timing of the rearrangement of the multiplying-factor symbol as he/she likes, leading to giving satisfaction to the player. Further, this configuration also allows to the player to change the timing of the rearrangement of the multiplying-factor symbol at any time during a game, leading to prevention of the player from getting bored.

The present invention provides a slot machine having the following configuration.

That is, the slot machine comprises a display and a controller.

The display is capable of rearranging normal symbols and a multiplying-factor symbol corresponding to a number. The controller is programmed to execute processing of: (A) rearranging the normal symbols and the multiplying-factor symbol to the display in such a manner that the multiplying-factor symbol is rearranged at a timing of a first or last rearrangement in rearrangements, when the multiplying-factor symbol is rearranged to the display; (B-2) determining, based on the numbers of the normal symbols of respective types rearranged in the processing (A), individual payout amounts for the respective types; and (C-2) paying out a special amount of game media and a standard amount of game media, the special payout amount being obtained by multiplying an amount obtained by summing the individual payout amounts for types satisfying a predetermined condition by the number corresponding to the multiplying-factor symbol rearranged in the processing (A), the standard payout amount being obtained by summing the individual payout amounts for types failing to satisfy the predetermined condition.

According to the aforementioned slot machine, the multiplying-factor symbol may be rearranged to the display. Further, each of the multiplying-factor symbols corresponds to a number. In case of the rearrangement of the multiplying-factor symbol to the display, the special payout amount of game media and the standard payout amount of game media are paid out. Here, the special payout amount is obtained by multiplying an amount obtained by summing the individual payout amounts for the types of the symbols satisfying the predetermined condition by the number corresponding to the multiplying-factor symbol, and the standard payout amount is obtained by summing the individual payout amounts for the types failing to satisfy the predetermined condition.

As described above, according to the aforementioned slot machine, in case of the rearrangement of the multiplying-factor symbol, the player can acquire a several times larger amount of game media for the types of the normal symbols satisfying the predetermined condition, resulting in enhancement of a sense of expectancy of the player for payouts. Therefore, it is possible to prevent the player from losing a sense of expectancy for payouts.

Further, since the multiplying-factor symbol capable of increasing several-fold an amount of game media that the player can acquire may be rearranged, it is possible to lead the player to have interests and concern for the rearrangement of the multiplying-factor symbol. Furthermore, since the player plays games with a great sense of expectancy for the rearrangement of the multiplying-factor symbol, it is possible to prevent the player from getting bored with games soon.

Furthermore, since only the payout amounts for the types of the normal symbols satisfying the predetermined condition are increased several-fold, it is possible to lead the player to have interests and concern for whether or not the respective normal symbols satisfy the predetermined condition.

Further, according to the aforementioned slot machine, the multiplying-factor symbol is rearranged at the timing of the first rearrangement or the last rearrangement. That is, symbols are rearranged in either one of the following patterns: a pattern in which the multiplying-factor symbol is rearranged after rearranging the normal symbols; and a pattern in which the normal symbols are rearranged after rearranging the multiplying-factor symbol.

In the case where the symbols are rearranged in the pattern in which the multiplying-factor symbol is rearranged after rearranging the normal symbols, the multiplying-factor symbol will be rearranged after the player roughly recognizes the normal payout amount determined by the result of the rearrangement of the normal symbols. For example, when the player finds that the rearranged normal symbols results in a prize that offers a relatively large amount of a payout, the player waits for the rearrangement of the multiplying-factor symbol with expectation for a further increase in the amount of the payout. On the contrary, when the player finds that the rearranged normal symbols results in no payout, since the rearrangement of the multiplying-factor symbol only results in no increase in an amount of a payout, the player does not expect the rearrangement of the multiplying-factor symbol. In this way, this configuration allows the player to have emotional ups or downs depending on rearranged normal symbols, resulting in further enhancement of entertainment of the games. As a result, it is possible to offer a game that possibly avoids a tendency of the player to get bored for a long period of time.

On the other hand, in the case where the symbols are rearranged in the pattern in which the normal symbols are rearranged after rearranging the multiplying-factor symbol, normal symbols will be rearranged after the player recognizes the multiplying-factor indicated by the multiplying-factor symbol. For example, when a multiplying-factor symbol indicative of a large number is rearranged followed by the rearrangement of normal symbols that results in a prize offering a large amount of a payout, the player can acquire a significantly large number of game media, resulting in significant enhancement of a sense of expectancy of the player for payouts. Therefore, it is possible to prevent the player from losing a sense of expectancy for payouts.

Further, the slot machine of the present invention preferably has the following configuration.

That is, the controller is further programmed to execute processing of: (D) determining either one of the first rearrangement or the last rearrangement as the timing of the rearrangement of the multiplying-factor symbol in the processing of (A). The processing (A) is processing for rearranging the multiplying-factor symbol to the display at the timing determined in the processing (D).

As described above, according to the aforementioned slot machine, either one of patterns is determined as the timing of the rearrangement of the multiplying-factor symbol, out of the following patterns: a pattern in which the multiplying-factor symbol is rearranged after rearranging the normal symbols; and a pattern in which the normal symbols are rearranged after rearranging the multiplying-factor symbol. Accordingly, for example, this configuration allows the player to change the pattern of the rearrangement of the multiplying-factor symbol, depending on the game state or as he/she likes. Therefore, compared to a configuration in which a multiplying-factor symbol is always rearranged at the timing of the first rearrangement or in which a multiplying-factor symbol is always rearranged at the timing of the last rearrangement, this configuration can offer a game that possibly avoids a tendency of the player to get bored.

Further, the slot machine of the present invention preferably has the following configuration.

That is, the controller is further programmed to execute processing of: (E) determining types of normal symbols to be rearranged to the display, before the processing (A). The processing (D) is processing for determining either one of the first rearrangement or the last rearrangement as the timing of the rearrangement of the multiplying-factor symbol in the processing (A), based on the types of the normal symbols determined in the processing (E).

As described above, according to the aforementioned slot machine, based on the types of the normal symbols determined to be rearranged, either one of patterns is determined as the timing of the rearrangement of the multiplying-factor symbol, out of the following patterns: a pattern in which the multiplying-factor symbol is rearranged after rearranging the normal symbols; and a pattern in which the normal symbols are rearranged after rearranging the multiplying-factor symbol. Therefore, for example, when the multiplying symbol is rearranged at the timing of the first rearrangement, the player is allowed to predict types of normal symbols to be rearranged. In this way, such an action as predicting types of normal symbols to be rearranged allows the player to enjoy the games well.

Further, the slot machine of the present invention preferably has the following configuration.

That is, the controller is further programmed to execute processing of: (F) determining the numbers of the normal symbols of the respective types to be rearranged to the display, before the processing (A). The processing (D) is processing for determining either one of the first rearrangement or the last rearrangement as the timing of the rearrangement of the multiplying-factor symbol in the processing (A), based on the numbers of the normal symbols of the respective types determined in the processing (F).

As described above, according to the aforementioned slot machine, based on the numbers of the normal symbols of the respective types determined to be rearranged, either one of patterns is determined as the timing of the rearrangement of the multiplying-factor symbol, out of the following patterns: a pattern in which the multiplying-factor symbol is rearranged after rearranging normal symbols; and a pattern in which normal symbols are rearranged after rearranging the multiplying-factor symbol. The normal payout amount is determined based on the numbers of the normal symbols of the respective types determined to be rearranged.

Therefore, the pattern of the rearrangement is determined according to the normal payout amount. For example, when the normal payout amount is relatively smaller and the multiplying-factor symbol is rearranged at the timing of the last rearrangement, the last rearrangement of a multiplying-factor symbol having a large multiplying factor set therefore pleases the player who is disappointed with establishment of only a prize that offers a small amount of a payout. Further, for example, when the normal payout amount is relatively lager and the multiplying-factor symbol is rearranged at the timing of the last rearrangement, the multiplying-factor symbol will be rearranged after the player recognizes establishment of a prize that offers a large amount of a payout. Therefore, it is possible to lead the player to have a sense of expectancy for further increase in the amount of the payout.

Further, the slot machine of the present invention preferably has the following configuration.

That is, the slot machine comprises an input device enabling a player to input commands associated with games. The controller is further programmed to execute processing of: (G) accepting from the input device an input for selecting either one the first rearrangement or the last rearrangement as the timing of the rearrangement of the multiplying-factor symbol in the processing (A). The processing (D) is processing for determining either one of the first rearrangement or the last rearrangement as the timing of the rearrangement of the multiplying-factor symbol in the processing (A), based on the input inputted by the input device in the processing (G).

As described above, according to the aforementioned slot machine, either one of patterns is determined by the player's selection as the timing of the rearrangement of the multiplying-factor symbol, out of the following patterns: a pattern in which the multiplying-factor symbol is rearranged after rearranging the normal symbols; and a pattern in which the normal symbols are rearranged after rearranging the multiplying-factor symbol. Accordingly, this configuration allows the player to set the timing of the rearrangement of the multiplying-factor symbol as he/she likes, leading to giving satisfaction to the player. Further, this configuration also allows to the player to change the timing of the rearrangement of the multiplying-factor symbol at any time during a game, leading to prevention of the player from getting bored.

Further, the present invention provides a controlling method of a slot machine.

That is, the controlling method of a slot machine comprises steps of: (A) rearranging normal symbols and a multiplying-factor symbol corresponding to a number to the display in such a manner that the multiplying-factor symbol is rearranged at a timing of a first or last rearrangement in rearrangements, when the multiplying-factor symbol is rearranged to the display; (B-1) determining a normal payout amount, based on the numbers of the normal symbols of respective types rearranged in the processing (A); and (C-1) paying out game media in amount obtained by multiplying the normal payout amount determined in the processing (B-1) by the number corresponding to the multiplying-factor symbol rearranged in the processing (A).

According to the aforementioned controlling method of a slot machine, the multiplying-factor symbol may be rearranged to the display. Further, each of the multiplying-factor symbols corresponds to a number. The rearrangement of the multiplying-factor symbol to the display causes paying out of game media in amount obtained by multiplying the normal payout by the number corresponding to the multiplying-factor symbol.

As described above, according to the aforementioned controlling method of a slot machine, in case of the rearrangement of the multiplying-factor symbol, the player can acquire a several times larger amount of game media, resulting in enhancement of a sense of expectancy of the player for payouts. Therefore, it is possible to prevent the player from losing a sense of expectancy for payouts.

Further, since the multiplying-factor symbol capable of increasing several-fold an amount of game media that the player can acquire may be rearranged, it is possible to lead the player to have interests and concern for the rearrangement of the multiplying-factor symbol. Furthermore, since the player plays games with a great sense of expectancy for the rearrangement of the multiplying-factor symbol, it is possible to prevent the player from getting bored with games soon.

Further, according to the aforementioned controlling method of a slot machine, the multiplying-factor symbol is rearranged at the timing of the first rearrangement or the last rearrangement. That is, symbols are rearranged in either one of the following patterns: a pattern in which the multiplying-factor symbol is rearranged after rearranging the normal symbols; and a pattern in which the normal symbols are rearranged after rearranging the multiplying-factor symbol.

In the case where the symbols are rearranged in the pattern in which the multiplying-factor symbol is rearranged after rearranging normal symbols, the multiplying-factor symbol will be rearranged after the player roughly recognizes the normal payout amount determined by the result of the rearrangement of the normal symbols. For example, when the player finds that the normal symbols rearranged results in a prize that offers a relatively large amount of a payout, the player waits for the rearrangement of the multiplying-factor symbol with expectation for a further increase in the amount of the payout. On the contrary, when the player finds that the normal symbols rearranged results in no payout, since the rearrangement of the multiplying-factor symbol only results in no increase in an amount of a payout, the player does not expect the rearrangement of the multiplying-factor symbol. In this way, this configuration allows the player to have emotional ups or downs depending on rearranged normal symbols, resulting in further enhancement of entertainment of the games. As a result, it is possible to offer a game that possibly avoids a tendency of the player to get bored for a long period of time.

On the other hand, in the case where the symbols are rearranged in the pattern in which the normal symbols are rearranged after rearranging the multiplying-factor symbol, the normal symbols will be rearranged after the player recognizes the multiplying-factor indicated by the multiplying-factor symbol. For example, when a multiplying-factor symbol indicative of a large number is rearranged followed by the rearrangement of normal symbols that results in a prize offering a large amount of a payout, the player can acquire a significantly large number of game media, resulting in significant enhancement of a sense of expectancy of the player for payouts. Therefore, it is possible to prevent the player from losing a sense of expectancy for payouts.

Further, the present invention provides a controlling method of a slot machine.

That is, the controlling method of a slot machine comprises steps of: (A) rearranging normal symbols and a multiplying-factor symbol to the display in such a manner that the multiplying-factor symbol is rearranged at a timing of a first or last rearrangement, when the multiplying-factor symbol is rearranged to the display; (B-2) determining, based on the numbers of the normal symbols of respective types rearranged in the processing (A), individual payout amounts for the respective types; and (C-2) paying out a special amount of game media and a standard amount of game media, the special payout amount being obtained by multiplying an amount obtained by summing the individual payout amounts for types satisfying a predetermined condition by the number corresponding to the multiplying-factor symbol rearranged in the processing (A), the standard payout amount being obtained by summing the individual payout amounts for types failing to satisfy the predetermined condition.

According to the aforementioned controlling method of a slot machine, the multiplying-factor symbol may be rearranged. Further, each of the multiplying-factor symbols corresponds to a number. In case of the rearrangement of the multiplying-factor symbol, the special payout amount of game media and the standard payout amount of game media are paid out. Here, the special payout amount is obtained by multiplying an amount obtained by summing the individual payout amounts for the types of the symbols satisfying the predetermined condition by the number corresponding to the multiplying-factor symbol, and the standard payout amount is obtained by summing the individual payout amounts for the types failing to satisfy the predetermined condition.

As described above, according to the aforementioned controlling method of a slot machine, in case of the rearrangement of the multiplying-factor symbol, the player can acquire a several times larger amount of game media for the types of the normal symbols satisfying the predetermined condition, resulting in enhancement of a sense of expectancy of the player for payouts. Therefore, it is possible to prevent the player from losing a sense of expectancy for payouts.

Further, since the multiplying-factor symbol capable of increasing several-fold an amount of game media that the player can acquire may be rearranged, it is possible to lead the player to have interests and concern for the rearrangement of the multiplying-factor symbol. Furthermore, since the player plays games with a great sense of expectancy for the rearrangement of the multiplying-factor symbol, it is possible to prevent the player from getting bored with games soon.

Furthermore, since only the payout amounts for the types of the normal symbols satisfying the predetermined condition are increased several-fold, it is possible to lead the player to have interests and concern for whether or not the respective normal symbols satisfy the predetermined condition.

Further, according to the aforementioned controlling method of a slot machine, the multiplying-factor symbol is rearranged at the timing of the first rearrangement or the last rearrangement. That is, symbols are rearranged in either one of the following patterns: a pattern in which the multiplying-factor symbol is rearranged after rearranging the normal symbols; and a pattern in which the normal symbols are rearranged after rearranging the multiplying-factor symbol.

In the case where the symbols are rearranged in the pattern in which the multiplying-factor symbol is rearranged after rearranging the normal symbols, the multiplying-factor symbol will be rearranged after the player roughly recognizes the normal payout amount determined by the result of the rearrangement of the normal symbols. For example, when the player finds that the rearranged normal symbols results in a prize that offers a relatively large amount of a payout, the player waits for the rearrangement of the multiplying-factor symbol with expectation for a further increase in the amount of the payout. On the contrary, when the player finds that the rearranged normal symbols results in no payout, since the rearrangement of the multiplying-factor symbol only results in no increase in an amount of a payout, the player does not expect the rearrangement of the multiplying-factor symbol. In this way, this configuration allows the player to have emotional ups or downs depending on rearranged normal symbols, resulting in further enhancement of entertainment of the games. As a result, it is possible to offer a game that possibly avoids a tendency of the player to get bored for a long period of time.

On the other hand, in the case where the symbols are rearranged in the pattern in which the normal symbols are rearranged after rearranging the multiplying-factor symbol, normal symbols will be rearranged after the player recognizes the multiplying-factor indicated by the multiplying-factor symbol. For example, when a multiplying-factor symbol indicative of a large number is rearranged followed by the rearrangement of normal symbols that results in a prize offering a large amount of a payout, the player can acquire a significantly large number of game media, resulting in significant enhancement of a sense of expectancy of the player for payouts. Therefore, it is possible to prevent the player from losing a sense of expectancy for payouts.

### BRIEF DESCRIPTIONS OF DRAWINGS

FIG. 1A is a view illustrating an exemplary symbol matrix.

FIG. 1B is another view illustrating an exemplary symbol matrix.

FIG. 1C is a view illustrating an exemplary image which is displayed to a lower image display panel.

FIG. 1D is another view illustrating another exemplary image which is displayed to the lower image display panel.

FIG. 1E is another view illustrating another exemplary image which is displayed to the lower image display panel.

FIG. 1F is another view illustrating another exemplary image which is displayed to the lower image display panel.

FIG. 1G is another view illustrating another exemplary image which is displayed to the lower image display panel.

FIG. 1H is another view illustrating another exemplary image which is displayed to the lower image display panel.

FIG. 2 is a view illustrating the relationships between the numbers of rearranged normal symbols and individual payout amounts.

FIG. 3 is a perspective view illustrating the external appearance of a slot machine.

FIG. 4 is a block diagram illustrating an internal configuration of the slot machine illustrated in FIG. 3.

FIG. 5A is a flowchart illustrating a subroutine of slot machine game execution processing according to the present embodiment.

FIG. 5B is a flowchart illustrating a subroutine of slot machine game execution processing according to the present embodiment.

FIG. 6 is a flowchart illustrating a subroutine of symbol rearrangement processing.

FIG. 7 is a flowchart illustrating a subroutine of timing setting processing.

FIG. 8A is a flowchart illustrating a subroutine of free-game execution processing.

FIG. 8B is a flowchart illustrating a subroutine of free-game execution processing.

FIG. 9 is a perspective view illustrating an external appearance of a slot machine according to another embodiment.

### DESCRIPTION OF THE EMBODIMENTS

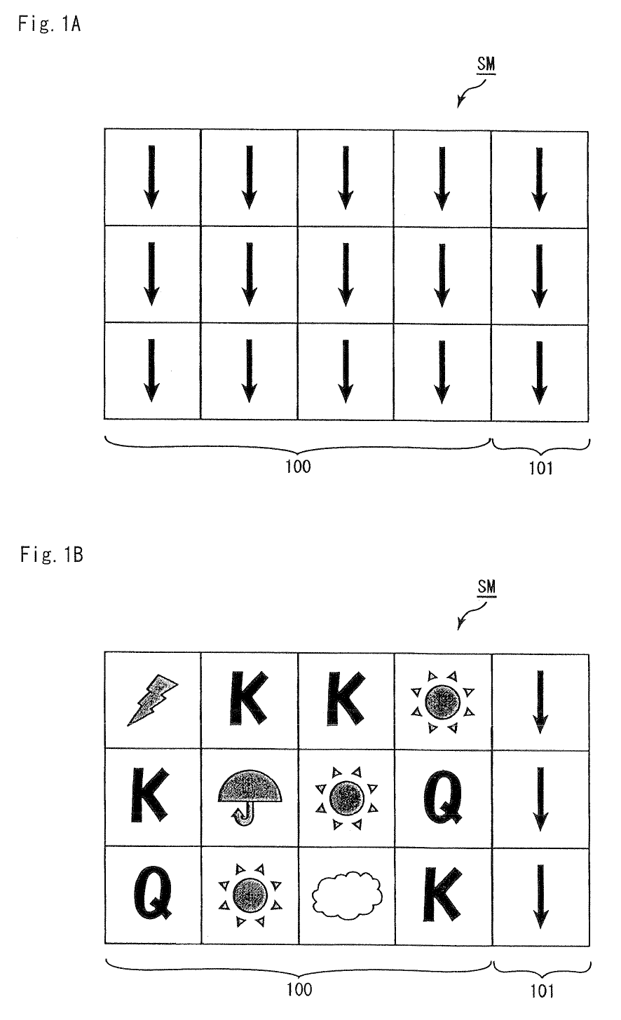

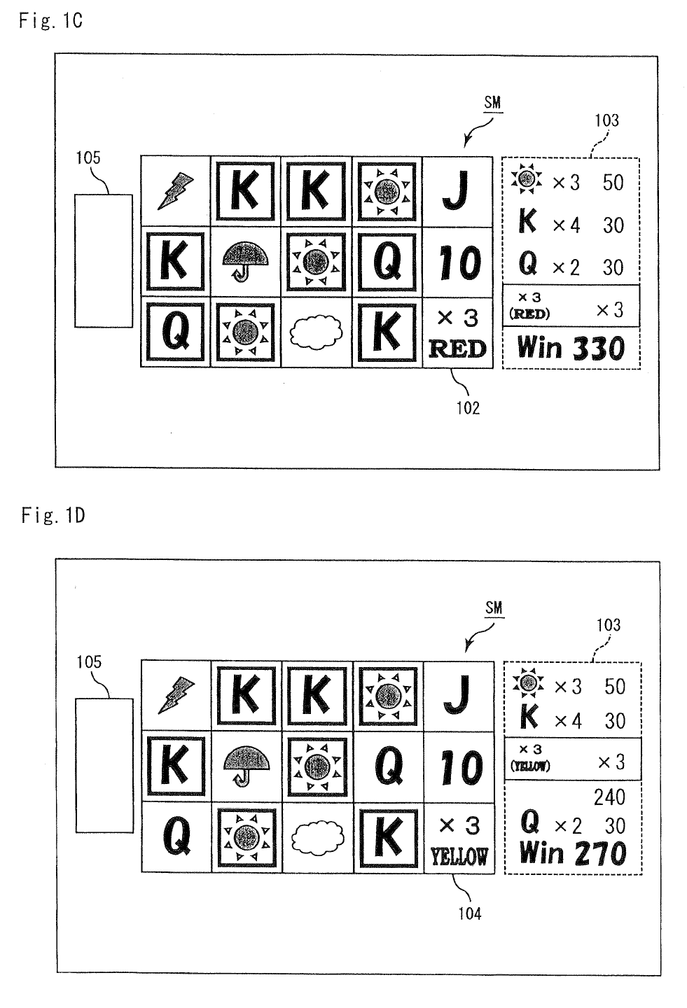

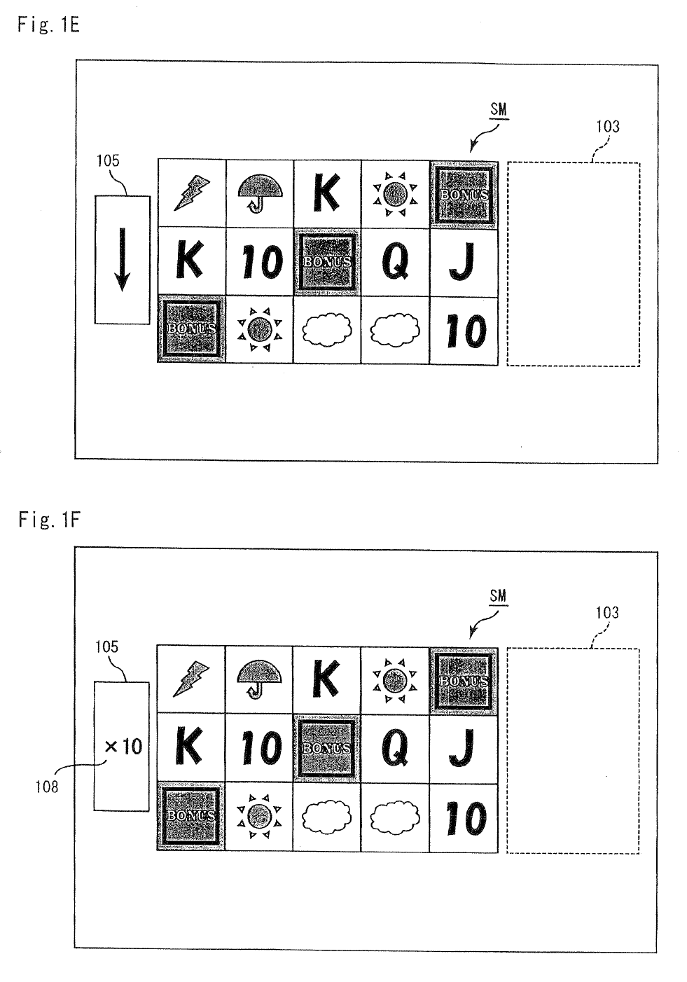

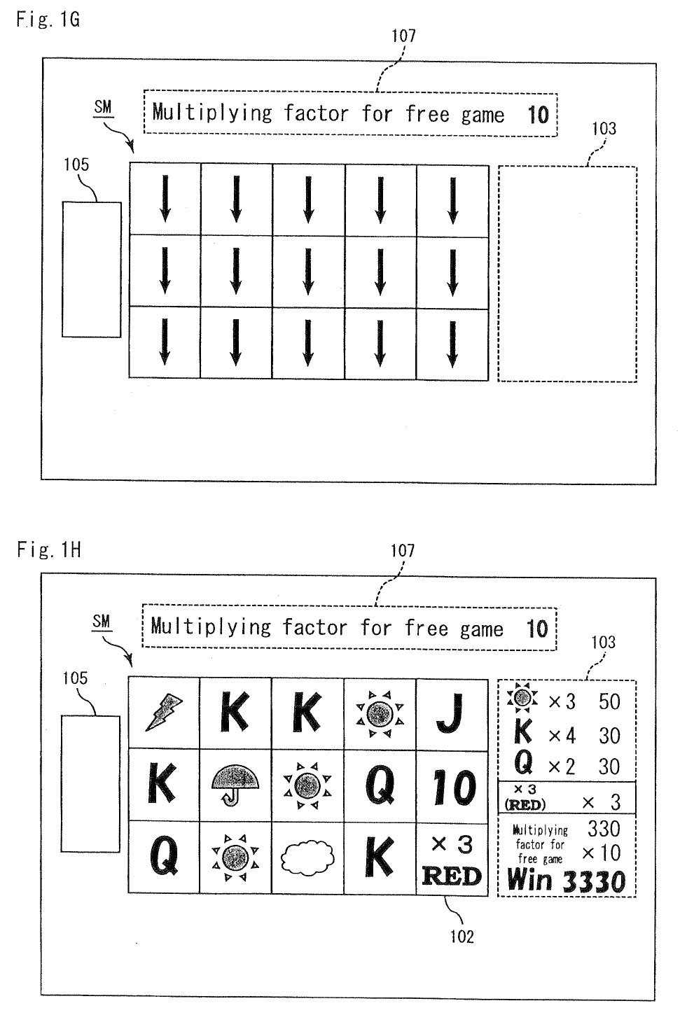

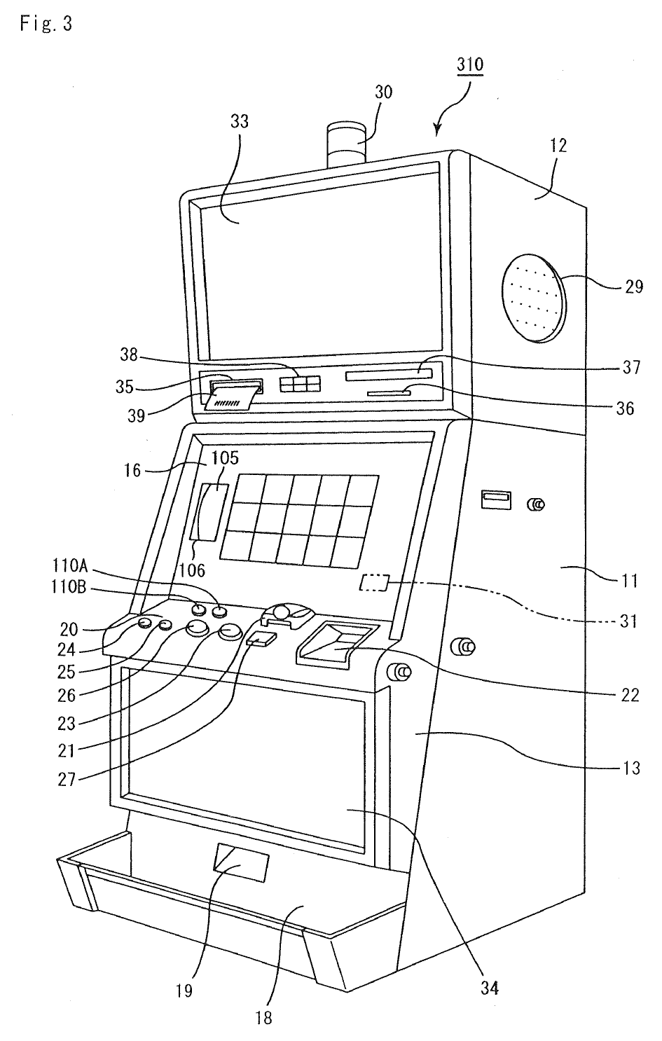

In a slot machine 10 (see FIG. 3) according to the present embodiment, a multiplying-factor symbol (for example, a red multiplying-factor symbol 102 (see FIG. 1C) or a yellow multiplying-factor symbol 104 (see FIG. 1D)) is rearranged in a symbol matrix SM. In addition, by a multiplying-factor reel 106 (see FIG. 3), a multiplying-factor symbol (a multiplying-factor symbol 108 for free games (see FIG. 1F)) is stop-displayed. Thus, in the present embodiment, two types of multiplying-factor symbols are used. Hereinafter, the multiplying-factor symbol rearranged in the symbol matrix SM is also referred to a multiplying-factor symbol for the symbol matrix SM. Further, hereinafter, the multiplying-factor symbol stop-displayed by the multiplying-factor reel 106 is also referred to a multiplying-factor symbol for the multiplying-factor reel.

Out of these multiplying-factor symbols, the multiplying-factor symbol for the symbol matrix SM corresponds to the multiplying-factor symbol in the present invention.

When the multiplying-factor symbol for the symbol matrix SM or the multiplying-factor symbol for the multiplying-factor reel is rearranged or stop-displayed, based on the number N (the symbol N is an integral number of 2 or more) displayed on the rearranged or stop-displayed multiplying factor symbol, the number of coins to be offered to a player increases N-fold at the maximum.

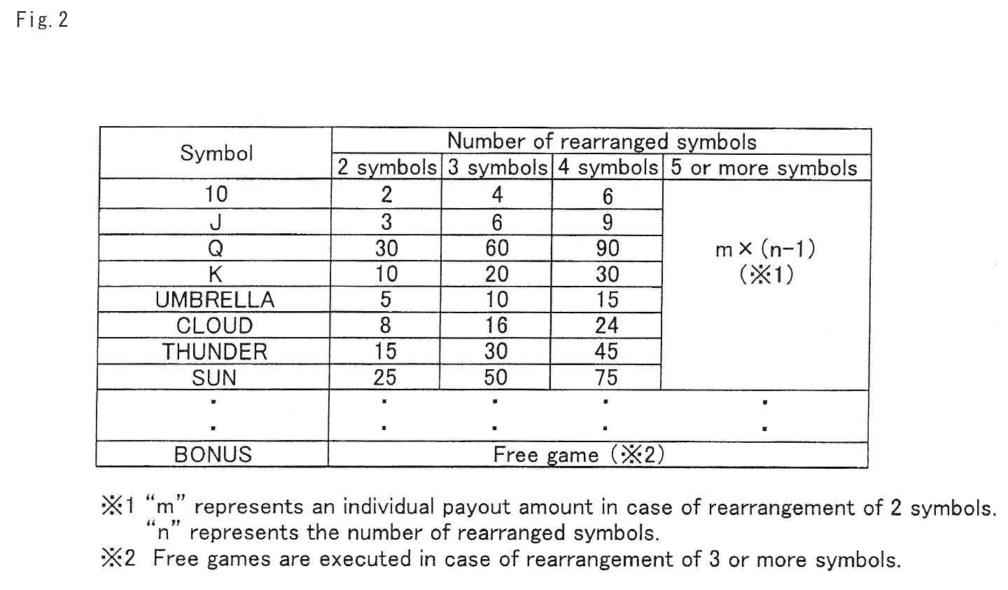

Hereinafter, with reference to FIGS. 1 and FIG. 2, the outline of the present embodiment will be described.

FIGS. 1A and 1B are views each illustrating an exemplary symbol matrix.

Each symbol matrix SM illustrated in FIGS. 1A and 1B is the symbol matrix SM displayed to a lower image display panel 16 (the display of the present invention) provided in the slot machine 10 (see FIG. 3). The symbol matrix SM is constituted by a normal-symbol display area 100 and a multiplying-factor-symbol display area 101. The normal-symbol display area 100 is capable of rearranging a total of 12 symbols along 3 rows and 4 columns. The multiplying-factor-symbol display area 101 is capable of displaying three normal symbols or a combination of two normal symbols and a single multiplying-factor symbol.

Hereinafter, both of the normal symbols and the multiplying-factor symbols are simply referred to symbols.

When the player presses a start button 23 (see FIG. 3) provided in the slot machine 10, scrolling of symbols starts in the symbol matrix SM, as illustrated in FIG. 1A.

Subsequently, 15 normal symbols or a combination of 14 normal symbols and a single multiplying-factor symbol are rearranged. The symbols are rearranged in either of the following two patterns.

Pattern I: After rearranging 12 normal symbols in the normal-symbol display area 100, three normal symbols or a combination of two normal symbols and a single multiplying-factor symbol are rearranged in the multiplying-factor-symbol display area 101.

Pattern II: After rearranging three normal symbols or a combination of two normal symbols and a single multiplying-factor symbol in the multiplying-factor-symbol display area 101, 12 normal symbols are rearranged in the normal-symbol display area 100.

FIG. 1B illustrates the case where symbols are rearranged in Pattern I.

Which pattern to be employed in the rearrangements is determined based on operation of timing selection buttons 110A, 110B (see FIG. 3) by the player, or types and the number of normal symbols to be rearranged. Hereinafter, the pattern of the rearrangements determined based on operation of the timing selection buttons 110A, 110B or the types and the number of normal symbols to be rearranged is also referred to “setting of timing”.

First, there will be described a case where timing is set by operation of the timing setting buttons 110A, 110B.

The slot machine 10 is provided with a last-rearrangement selection button 110A and a first-rearrangement selection button 110B (see FIG. 3). Hereinafter, these two buttons together are also referred to timing selection buttons 110. The player can select a single timing by pressing one of the timing selection buttons 110.

In the case where the last-rearrangement selection button 110A is pressed, Pattern I is determined as the pattern of the rearrangements. That is, the press of the last-rearrangement selection button 110A by the player means that the rearrangements are set in such a manner that after rearranging the normal symbols in the normal-symbol display area 100, a multiplying-factor symbol is rearranged in the multiplying-factor-symbol display area 101.

On the other hand, in the case where the first-rearrangement selection button 110B is pressed, Pattern II is determined as the pattern of the rearrangements. That is, the press of the first-rearrangement selection button 110B by the player means that the rearrangements are set in such a manner that before rearranging the normal symbols in the normal-symbol display area 100, a multiplying-factor symbol is rearranged in the multiplying-factor-symbol display area 101.

In the case where neither of the last-rearrangement selection button 110A nor the first-rearrangement selection button 110B is pressed, the pattern of the rearrangement is determined based on the types and the number of normal symbols to be rearranged.

Hereinafter, timing setting in this case will be described.

When the start button 23 provided in the slot machine 10 is pressed by the player, symbols to be rearranged in the symbol matrix SM are determined using random numbers. Then, based on the normal symbols determined to be rearranged, a normal payout amount is determined. When the normal payout amount is equal to or less than a predetermined amount, Pattern I is determined as the pattern of the rearrangements. On the other hand, when the amount of the payout is more than the predetermined amount, Pattern II is determined as the pattern of the rearrangements.

Here, a calculation method of payout amounts will be described with reference to FIGS. 1C, 1D, and FIG. 2. The normal payout amount and individual payout amounts will also be described.

FIGS. 1C and 1D are views each illustrating an exemplary image displayed to the lower image display panel.

FIG. 2 is a view illustrating the relationships between the numbers of rearranged normal symbols and amounts of individual payouts.

As illustrated in FIG. 2, the individual payout amounts are determined so as to correspond to types and the numbers of rearranged normal symbols. In FIG. 2, “10”, “J”, “Q”, “K”, “UMBRELLA”, “CLOUD”, “THUNDER”, and “SUN” are illustrated as examples of the normal symbols. The normal symbols of the present embodiment are constituted by so-called scatter symbols.

For example, as illustrated in FIG. 1C, when three “SUNs” are rearranged, the individual payout amount is an amount corresponding to 50 coins. Further, when four “Ks” are rearranged, the individual payout amount is an amount corresponding to 30 coins. Furthermore, when two “Qs” are rearranged, the individual payout amount is an amount corresponding to 30 coins.

As described above, the individual payout amounts are calculated for the respective types of the normal symbols.

The normal payout amount is an amount obtained by adding the individual payout amounts for the respective types of the symbols. In the example illustrated in FIG. 1C, the normal payout amount is an amount corresponding to 50+30+30=110 coins (see number-of-payouts display section 103 of FIG. 1C).

As described above, when a multiplying-factor symbol is rearranged in the multiplying-factor-symbol display area 101, the payout amount increases N-fold at the maximum. In the present embodiment, each multiplying-factor symbol and each normal symbol have one of colors of red, blue and yellow. A degree of increase of the payout amount changes according to the colors of the rearranged symbols.

A red multiplying-factor symbol 102 is rearranged in the symbol matrix SM in the example illustrated in FIG. 1C. Although, in this example, the characters “RED” are displayed on the red multiplying-factor symbol 102, these characters are illustrated only for convenience of the description. In actual, the red multiplying factor symbol 102 has characters of “×3” that is colored red.

With respect to this point, a yellow multiplying factor symbol 104 in FIG. 1D is also illustrated in the same way.

As illustrated in FIG. 1C, in the case where the red multiplying-factor symbol 102 is rearranged, coins corresponding to the three-fold of the normal payout amount are paid out to the player regardless of colors of rearranged normal symbols (see number-of-payouts display section 103 of FIG. 1C).

On the other hand, as illustrated in FIG. 1D, when the yellow multiplying-factor symbol 104 is rearranged, normal symbols having a yellow color that is the same color as that of the yellow multiplying-factor symbol 104 (hereinafter, simply referred to “normal symbol colored the same”) are identified out of normal symbols rearranged in the symbol matrix SM.

In the example illustrated in FIG. 1D, the normal symbols enclosed by a frame represent symbols colored yellow. In this case, similarly, the normal symbols are illustrated as being enclosed by the frame for indicating which normal symbols are colored yellow for convenience of the description. However, in actual, the normal symbols are not displayed in such a way that they are enclosed by a frame. In actual, the normal symbols themselves have a color, so that the player can immediately recognize which normal symbols have the yellow color, without a frame for enclosing the normal symbols.

When the normal symbols colored the same are identified, coins corresponding to the three-fold of the total sum of individual payout amounts for respective types of the normal symbols colored the same are paid out to the player. With respect to the normal symbol having a different color from that of the yellow multiplying factor symbol 104 (hereinafter, simply referred to “normal symbol differently colored”), coins corresponding to the total sum of the individual payout amounts for respective types of the normal symbols differently colored (without 3-fold multiplication) are paid out to the player (see the number-of-payouts display section 103 in FIG. 1D).

The calculation method of payout amounts has been described with reference to FIGS. 1C, 1D, and FIG. 2.

Next, free games conducted in the present embodiment will be described with reference to FIGS. 1E to 1H.

FIGS. 1E to 1H are views each illustrating an exemplary image displayed to the lower image display panel.

In the period of the free games, although game media are not BET, slot machine games are conducted. In the present specification, the slot machine game conducted in a period other than the period of free games is also referred to a normal game.

In the present embodiment, when three or more normal symbols “BONUSs” (see FIG. 2) are rearranged, free games generate.

In case of the rearrangement of three or more normal symbols “BONUSs”, the multiplying-factor symbols are varied and displayed in a multiplying-factor-symbol display area 105, as illustrated in FIG. 1E.

The multiplying-factor reel 106 is rotatably provided within the cabinet 11 (see FIG. 3) included in the slot machine 10. The symbol sequence constituted by a plurality of multiplying-factor symbols (characters of “×N” (the symbol N is an integer of 2 or larger)) is drawn on the outer peripheral surface of the multiplying-factor reel 106. In the multiplying-factor-symbol display area 105, there are formed a display window visible through its back surface, and a multiplying-factor symbol drawn on the outer peripheral surface of the multiplying-factor reel 106 is displayed through the display window.

As illustrated in FIG. 1, after varying and displaying of the plurality of multiplying-factor symbols, a single multiplying-factor symbol is stop-displayed. In the example illustrated in FIG. 1F, a multiplying-factor symbol 108 for free games on which characters of “×10” are displayed is stop-displayed. In this example, a multiplying-factor for free games is determined to be 10. The multiplying factor for free games is a value referred when a payout amount is determined in free games.

As illustrated in FIG. 1G, in a multiplying-factor-for-free-games display area 107, an image of characters indicative of the multiplying factor for free games is displayed during the free games.

As illustrated in FIG. 1H, in free games, coins corresponding to an amount obtained by multiplying a payout amount in a normal game by the multiplying factor for free games is paid out (see the number-of-payouts display section 103).

There has been described the outline of the present embodiment, with reference to FIGS. 1A to 1H and FIG. 2.

Hereinafter, the present embodiment will be described in more detail.

FIG. 3 is a perspective view illustrating the external appearance of the slot machine.

In the slot machine 10, a coin, a bill, or electronic valuable information corresponding thereto is used as a game medium. However, in the present invention, a game medium is not particularly limited. Examples of the game medium may include a medal, a token, electronic money, or a ticket. It should be noted that the ticket is not particularly limited, and examples thereof include a ticket with a bar code, which will be described later.

Here, the slot machine 10 is a standalone type slot machine that is not connected to a network, but the present invention can also be applied to a slot machine connected to a network.

The slot machine 10 includes: a cabinet 11; a top box 12 placed on the upper side of the cabinet 11; and a main door 13 provided at the front face of the cabinet 11. The lower image display panel 16 is provided in front of the main door 13. The lower image display panel 16 includes a liquid crystal display panel which displays the symbol matrix SM (see FIGS. 1) constituted by the normal symbol display area 100 and the multiplying-factor-symbol display area 101. The lower image display panel 16 corresponds to the display of the present invention. In the lower image display panel 16, there are provided a number-of-credits display section 31 (not shown). The number-of-credits display section 31 displays an image indicating the number of credited coins.

In addition, as described above, there are provided the multiplying-factor-symbol display area 105 in the lower image display panel 16, and the player is allowed to see a multiplying-factor symbol displayed by the multiplying-factor reel 106.

Further, a touch panel 69, which is not shown in the figure, is provided on the front face of the lower image display panel 16, and the player can input various kinds of commands by operating the touch panel 69.

Below the lower image display panel 16, there are provided a control panel 20 comprised of a plurality of buttons 23 to 27 and 110 (110A and 110B) with each of which a command according to the game progress is inputted by the player, a coin receiving slot 21 through which a coin is accepted into the cabinet 11, and a bill validator 22.

The control panel 20 is provided with a start button 23, a change button 24, a CASHOUT button 25, a 1-BET button 26, and a maximum BET button 27. The start button 23 is used for inputting a command to start a game. The change button 24 is used for making a request of staff at a recreation facility for exchange. The CASHOUT button 25 is used for inputting a command to pay out credited coins to a coin tray 18.

The 1-BET button 26 is used for inputting a command to BET one coin on a game out of credited coins. The maximum BET button 27 is used for inputting a command to BET the maximum number (10 in the present embodiment) of coins that can be bet on a single game out of credited coins.

In addition, the last-rearrangement selection button 110A and the first-rearrangement selection button 110B are provided on the control panel 20. As described above, the player is allowed to select a single pattern out of Pattern I and Pattern II as the timing of the rearrangement of symbols by pressing either one of these timing selection buttons 110.

The bill validator 22 not only discriminates a regular bill from a false bill, but also accepts the regular bill into the cabinet 11. It should be noted that the bill validator 22 may be configured so as to be capable of reading a later-described ticket 39 with a barcode. At the lower front face of the main door 13, namely below the control panel 20, there is provided a belly glass 34 on which a character or the like of the slot machine 10 is drawn.

At the front face of the top box 12, an upper image display panel 33 is provided. The upper image display panel 33 is provided with a liquid crystal panel to display, for example, an image representing an introduction of the contents of a game or a description of a rule of the game.

Further, the top box 12 is provided with a speaker 29. Below the upper image display panel 33, there are provided a ticket printer 35, a card reader 36, a data display 37, and a keypad 38. The ticket printer 35 prints on a ticket a barcode as coded data of the number of credits, date and time, an identification number of the slot machine 10, and the like, and outputs the ticket as a ticket 39 with a barcode. The player can make another slot machine read the ticket 39 with a barcode to play a game thereon, or can exchange the ticket 39 with a barcode with bills or the like at a predetermined place in the recreation facility (for example, a cashier in a casino).

The card reader 36 reads data from a smart card and writes data into the smart card. The smart card is a card owned by the player, and for example, data for identifying a player and data on a history of games played by the player are stored therein. Data corresponding to a coin, a bill, or a credit may be stored in the smart card. Further, in place of the smart card, a magnetic stripe card may be adopted. The data display 37 is comprised of a fluorescent display or the like, and displays, for example, data read by the card reader 36 or data inputted by the player through the keypad 38. The keypad 38 is used for inputting a command and data concerning the issue of a ticket and the like.

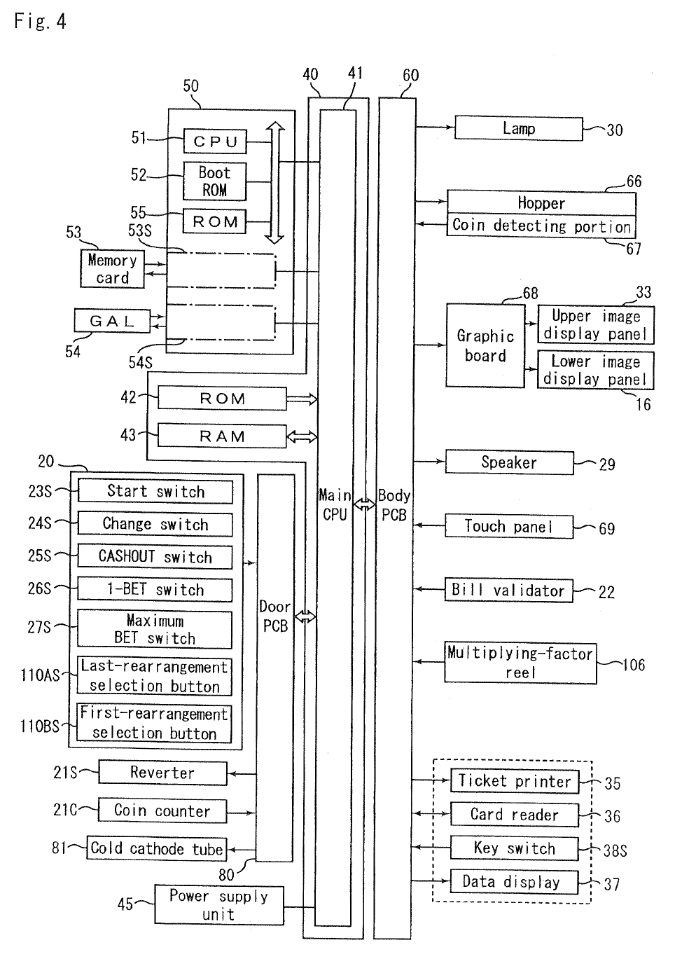

FIG. 4 is a block diagram showing an internal configuration of the slot machine shown in FIG. 3.

A gaming board 50 includes a CPU (Central Processing Unit) 51, a ROM 55, and a boot ROM 52 which are interconnected to one another via an internal bus, a card slot 53S corresponding to a memory card 53, and an IC socket 54S corresponding to a GAL (Generic Array Logic) 54.

The memory card 53 is formed from a nonvolatile memory such as CompactFlash (registered trademark) and stores game programs and game system programs. The game programs include a symbol selection program. The aforementioned symbol selection program is a program for determining the normal symbols and the multiplying-factor symbol to be rearranged in the symbol matrix SM and the multiplying-factor symbol to be stop-displayed by the multiplying-factor reel 106. The aforementioned symbol selection program includes symbol weighing data in association with plural types of payout ratios (for example, 80%, 84%, 88%). The symbol weighing data is data indicating the correspondence between the respective symbols, and one or more random numbers which fall in a predetermined numerical range (0 to 255). The payout ratios are determined based on payout-ratio setting data outputted from the GAL 54 and, based on the symbol weighing data associated with the payout ratios, the symbols to be rearranged in the symbol matrix SM and a multiplying-factor symbol to be stop-displayed by the multiplying-factor reel 106 are determined.

Further, the game programs include table data (see FIG. 2) indicative of the relationships between the numbers of rearranged normal symbols and the individual payout amounts.

Further, the card slot 53S is configured so as to allow the memory card 53 to be inserted thereinto or ejected therefrom, and is connected to a mother board 40 via an IDE bus. Thus, the memory card 53 can be ejected from the card slot 53S, and then another game program is written onto the memory card 53, and the memory card 53 can be inserted into the card slot 53S, to change the type and contents of a game to be played on the slot machine 10. The game program includes a program associated with the progress of a game. The game program also includes image data and sound data to be outputted during the game. The image data includes image data and the like indicating a symbol matrix.

The GAL 54 is a type of PLD having a fixed OR array structure. The GAL 54 includes plural input ports and plural output ports and, when predetermined data is inputted to an input port, the GAL 54 outputs data corresponding to the aforementioned data from an output port. The data outputted from this output port is the aforementioned payout-ratio setting data.

Further, the IC socket 54S is configured to allow the GAL 54 to be attached thereto and detached therefrom and is connected to the mother board 40 through a PCI bus. Accordingly, the GAL 54 can be replaced with another GAL 54 to change the payout-ratio setting data.

CPU 51, ROM 55 and boot ROM 52 interconnected to one another via an internal bus are connected to the mother board 40 by PCI bus.

The mother board 40 is constructed with a general-purpose mother board commercially available (a printed circuit board on which basic parts of a personal computer are mounted) and includes a main CPU 41, ROM (Read Only Memory) 42 and RAM (Random Access Memory) 43. The mother board 40 is the controller of the present invention.

ROM 42 is constituted of a memory device such as a flash memory and stores thereon a program such as BIOS (Basic Input/Output System) executed by the main CPU 41 and permanent data. When BIOS is executed by the main CPU 41, not only is initialization processing for predetermined peripheral devices conducted, but a capture processing for the game program and game system program stored on the memory card 53 is also started via the gaming board 50. In the present invention, contents of ROM 42 may be rewritable or not rewritable.

RAM 43 stores data and a program used at the time of operation of the main CPU 41, and various flags. RAM 43 can also store the game program. RAM 43 further stores data on the number of credits, the number of coins-in or coins-out for one game, and the like.

Further, in the RAM 43, there are provided a multiplying-factor-for-free-game storage area and a number-of-free-games storage area. The multiplying-factor-for-free-game storage area stores data indicative of a multiplying factor for free games. As described above, the multiplying factor for free games is a value referred when a payout amount is determined in the free games. The number-of-free-games storage area stores data indicative of the number of remaining free games.

To the mother board 40, a body PCB (Printed Circuit Board) 60 and a door PCB 80, which will be described later, are connected through respective USBs. Further, the mother board 40 is connected with a power supply unit 45.

The body PCB 60 and the door PCB 80 are connected with equipment and devices that generate input signals to be inputted to the main CPU 41, and equipment and devices operations of which are controlled by control signals outputted from the main CPU 41. The main CPU 41 executes a game program stored in the RAM 43 based on an input signal inputted to the main CPU 41, thereby executes the predetermined arithmetic processing and stores a result thereof in the RAM 43, or transmits a control signal to each of the equipment and devices as processing for controlling each of the equipment and devices.

To the body PCB 60, there are connected a lamp 30, a hopper 66, a coin detecting portion 67, a graphic board 68, a speaker 29, a touch panel 69, a bill validator 22, a ticket printer 35, a card reader 36, a key switch 38S, and a data display 37. The lamp 30 lights up in a predetermined pattern based on a control signal outputted from the main CPU 41.

The hopper 66 is installed inside the cabinet 11 and pays out a predetermined number of coins from the coin payout exit 19 to the coin tray 18, based on a control signal outputted from the main CPU 41. The coin detecting portion 67 is provided inside the coin payout exit 19, and outputs an input signal to the main CPU 41 when detecting a payout of a predetermined number of coins from the coin payout exit 19.

The graphic board 68 controls, based on a control signal outputted from the main CPU 41, an image display to the upper image display panel 33 and the lower image display panel 16. The number of credits stored in RAM 43 is displayed to the number-of-credits display section 31 (not shown) of the lower image display panel 16. The number of coins-out is displayed to the number-of-payouts display section 103 (see FIG. 1C, FIG. 1D and FIG. 1H) of the lower image display panel 16. An image of characters indicative of a multiplying factor for free games is displayed in the multiplying-factor-for-free-games display area 107 (see FIG. 1G) during the free games. The graphic board 68 is equipped with VDP (Video Display Processor) which generates image data based on a control signal outputted from the main CPU 41 and a video RAM which temporarily stores image data generated by VDP, and of the like equipments. It should be noted that image data used in generating image data with VDP is contained in a game program read from the memory card 53 and stored in RAM 43.

The bill validator 22 not only discriminates a regular bill from a false bill, but also accepts the regular bill into the cabinet 11. When accepting a regular bill, the bill validator 22 outputs an input signal to the main CPU 41, based on the face amount of the bill. The main CPU 41 stores, in the RAM 43, the number of credits according to the face amount of the bill transmitted with the input signal.

The ticket printer 35 prints on a ticket, based on a control signal outputted from the main CPU 41, a barcode formed by encoding data such as the number of credits, date and time, an identification number of the slot machine 10, and of the like data stored in the RAM 43, and outputs the ticket as a ticket 39 with a barcode.

The card reader 36 reads data from a smart card and transmits the data to the main CPU 41 or writes data into the smart card based on a control signal from the main CPU 41. The key switch 38S is provided on the keypad 38, and outputs a predetermined input signal to the main CPU 41 when the keypad 38 is operated by the player. The data display 37 displays, based on a control signal outputted from the main CPU 41, data read by the card reader 36 or data inputted by the player through the keypad 38.

To the door PCB 80, there are connected a control panel 20, a reverter 21S, a coin counter 21C, and a cold cathode tube 81. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. Each of the switches 23S to 27S outputs an input signal to the main CPU 41 when each of the buttons 23 to 27 corresponding thereto is operated by the player.

Further, in the control panel 20, there are provided an last-rearrangement selection switch 110AS corresponding to the last-rearrangement selection button 110A, and a first-rearrangement selection switch 110BS corresponding to the first-rearrangement selection button 110B. Each of the switches 110AS and 110BS outputs an input signal to the main CPU 41, when each of the buttons 110A and 110B corresponding thereto is operated by the player.

The coin counter 21C is provided inside the coin receiving slot 21 and discriminates a regular coin from a false coin inserted into the coin receiving slot 21 by the player. Coins other than regular coins are discharged from the coin payout exit 19. When the coin counter 21C detects a regular coin, the coin counter 21C outputs an input signal to the main CPU 41.

The reverter 21S operates based on a control signal outputted from the main CPU 41, and distributes a coin identified by the coin counter 21C as a regular coin into a cash box (not shown) or the hopper 66, which are disposed in the slot machine 10. Specifically, when the hopper 66 is filled with coins, a regular coin is distributed into the cash box by the reverter 21S. On the other hand, when the hopper 66 is not filled with coins, the regular coin is distributed into the hopper 66. The cold cathode tube 81 functions as a backlight installed on the rear face side of the lower image display panel 16 and the upper image display panel 33, and lights up based on a control signal to be outputted from the main CPU 41.

Next, processing executed on the slot machine 10 will be described.

The main CPU 41 reads a game program and executes the game program to progress a game.

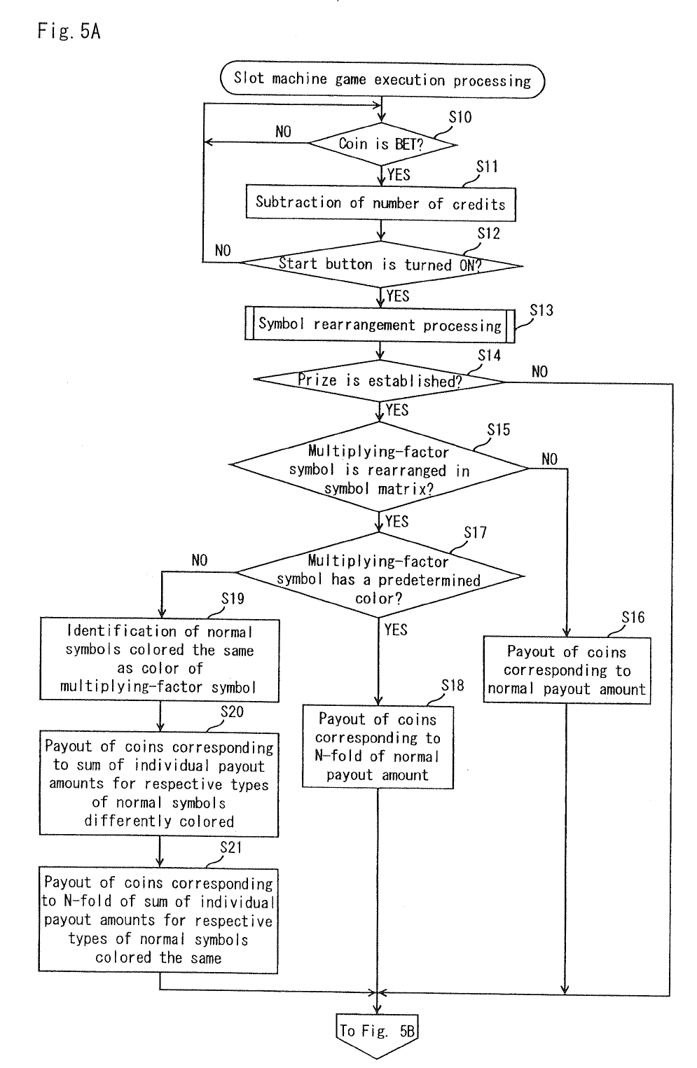

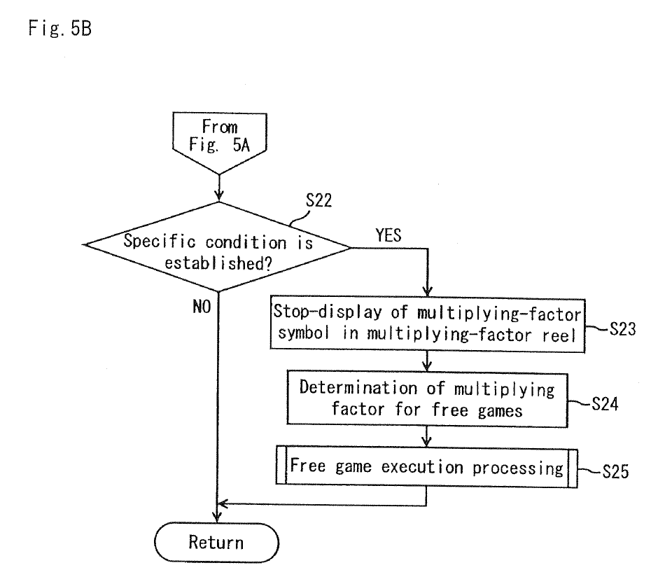

FIGS. 5A and 5B are flowcharts illustrating a subroutine of slot machine game execution processing according to the present embodiment.

In the slot machine game execution processing, first, the main CPU 41 determines whether or not a coin has been BET (step S10). In the processing, the main CPU 41 determines whether or not to have received an input signal outputted from the 1-BET switch 26S when the 1-BET button 26 is operated or an input signal outputted from the maximum BET switch 27S when the maximum BET button 27 is operated. When determining that a coin has not been BET, the main CPU 41 returns the processing to step S10.

On the other hand, when determining that a coin has been BET in step S10, the main CPU 41 executes processing for making a subtraction from the number of credits stored in the RAM 43, according to the number of BET coins (step S11). It should be noted that, when the number of BET coins is larger than the number of credits stored in the RAM 43, the main CPU 41 does not execute the processing for making a subtraction from the number of credits stored in the RAM 43, and returns the processing to step S10. When the number of BET coins exceeds an upper limit of the number of coins that can be BET on a single game (10 in the present embodiment), the main CPU 41 does not execute the processing for making a subtraction from the number of credits stored in the RAM 43, and the processing is proceeded to step S12.

Next, the main CPU 41 determines whether or not the start button 23 has been turned on (step S12). In the processing, the main CPU 41 determines whether or not to have received an input signal outputted from the start switch 23S when the start button 23 is pressed.

When determining that the start button 23 has not been turned ON, the main CPU 41 returns the processing to step S10. It should be noted that, when the start button 23 is not turned ON (for example, when a command to end the game is inputted without pressing the start button 23), the main CPU 41 cancels a result of the subtraction obtained in step S1.

On the other hand, when determining in step S12 that the start button 23 has been turned ON, the main CPU 41 executes symbol rearrangement processing (step S13).

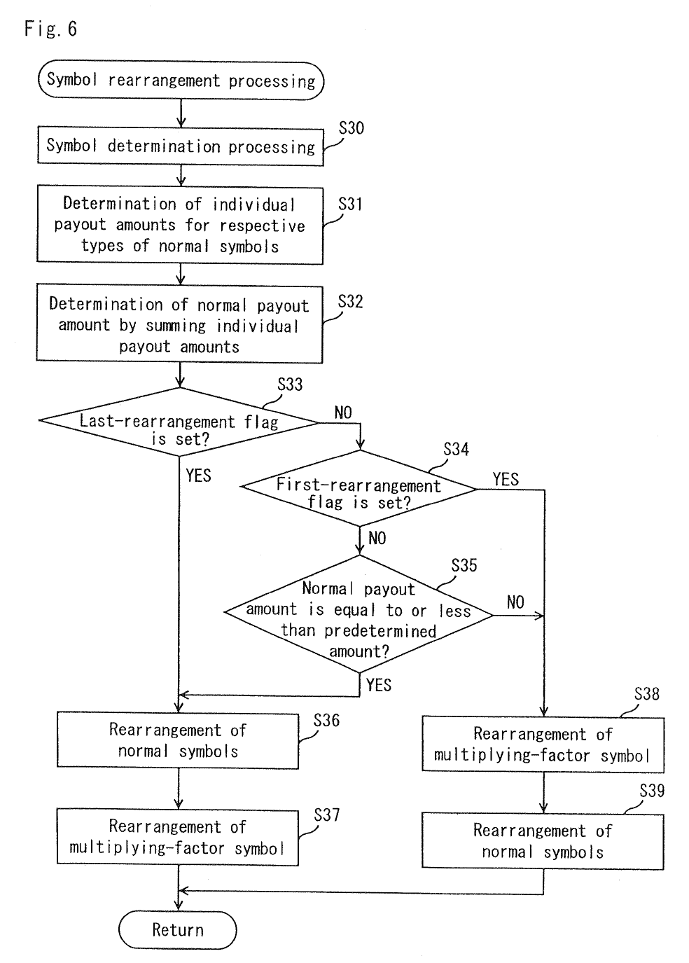

Here, the symbol rearrangement processing will be described with reference to FIG. 6.

FIG. 6 is a flowchart illustrating a subroutine of the symbol rearrangement processing.

First, the main CPU 41 executes the symbol determination processing (step S30). In the processing, the main CPU executes the aforementioned symbol selection program, and determines symbols (normal symbols or a combination of normal symbols and a multiplying-factor symbol) to be rearranged in the symbol matrix SM.

Next, the main CPU 41 determines individual payout amounts for respective types of normal symbols determined to be rearranged (step S31). In the processing, the main CPU 41 counts the numbers of the normal symbols of the respective types determined to be rearranged. Subsequently, the main CPU 41 determines the individual payout amounts for the respective types of the normal symbols, based on the counted numbers and table data (see FIG. 2) indicative of the relationships between the numbers of rearranged normal symbols and amounts of individual payouts. Then, the main CPU 41 stores the determined the individual payout amounts in the RAM 43.

Next, the main CPU 41 determines the normal payout amount that is an amount obtained as the total sum of the individual payout amounts, and stores the normal payout amount in the RAM 43 (step S32).

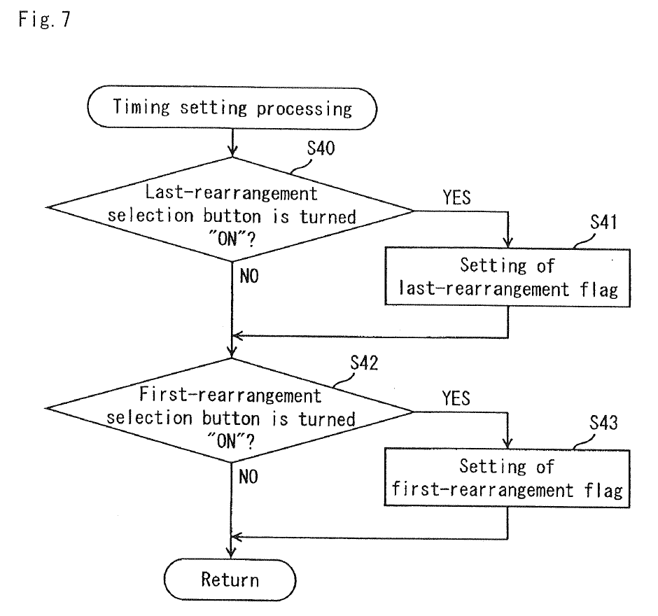

Next, the main CPU 41 determines whether or not a last-rearrangement flag is set (step S33). The last-rearrangement flag is a flag set in the event that the last-rearrangement selection 110A is pressed (see step S41 in FIG. 7).

When determining that the last-rearrangement flag is not set, the CPU 41 determines whether or not a first-rearrangement flag is set (step S34). The first-rearrangement flag is a flag set in the event that the first-rearrangement selection button 110B is pressed (see step S43 in FIG. 7).

Here, the last-rearrangement flag and the first-rearrangement flag will be described with reference to FIG. 7.

FIG. 7 is a flowchart illustrating a subroutine of the timing setting processing.

First, the main CPU 41 determines whether or not the last-rearrangement selection button 110A is turned “ON” on a predetermined timing (step S40). In the processing, the main CPU 41 determines whether or not to have received an input signal outputted from the last-rearrangement selection switch 110AS when the last-rearrangement selection button 110A is pressed.

When the CPU 41 determines the last-rearrangement selection button 110A is turned “ON”, the main CPU 41 sets the last-rearrangement flag in the RAM 43 (step S41).

When determining in step S40 that the last-rearrangement selection button 110A is not turned “ON”, or after execution of the processing of step S41, the main CPU 41 determines whether or not the first-rearrangement selection button 110B is turned “ON” (step S42). In the processing, the main CPU 41 determines whether or not to have received an input signal outputted from the first-rearrangement selection switch 110BS when the first-rearrangement selection button 110B is pressed.

When determining that the first-rearrangement selection button 110B is turned “ON”, the main CPU 41 sets the first-rearrangement flag in the RAM 43 (step S43).

When determining in step S42 that the first-rearrangement selection button is not turned “ON”, or after execution of the processing of step S43, the main CPU 41 ends the present subroutine.

The last-rearrangement flag and the first-rearrangement flag have been described with reference to FIG. 7.

When the main CPU 41, the ROM 42 and the RAM 43 execute the processing of step S40 and step S42 in cooperation with one another, the main CPU 41, the ROM 42 and the RAM 43 function as the controller for executing the processing (G) of the present invention.

Hereinafter, FIG. 6 will be described again.

When determining in step S34 that the first-rearrangement flag is not set, the main CPU 41 determines whether or not the normal payout amount determined in step S32 is equal to or less than a predetermined amount (step S35).

When determining in step S33 that the last-rearrangement flag is set, or determining in step S35 that the normal payout amount is equal to or less than the predetermined amount, the main CPU 41 rearranges 12 normal symbols in the normal symbol display area 100 (step S36).

Subsequently, when the main CPU 41 determines in step S30 to rearrange a multiplying-factor symbol, the multiplying-factor symbol and two normal symbols are rearranged in the multiplying-factor-symbol display area 101 (step S37). On the other hand, when the main CPU determines in step S30 not to rearrange a multiplying-factor symbol, three normal symbols are rearranged in the multiplying-factor-symbol display area 101 (step S37).

When determining in step S34 that the first-rearrangement flag is set, or determining in step S35 that the normal payout amount is more than the predetermined amount, the main CPU shifts the processing to step S38.

When the main CPU 41 determines in step S30 to rearrange a multiplying-factor symbol, the main CPU 41 rearranges the multiplying-factor symbol and two normal symbols in the multiplying-factor-symbol display area 101 (step S38) On the other hand, when the main CPU 41 determined in step S30 not to rearrange a multiplying-factor symbol, the main CPU 41 rearranges three normal symbols in the multiplying-factor-symbol display area 101 (step S38).

Subsequently, the main CPU 41 rearranges 12 normal symbols in the normal-symbol display area 100 (step S39).

After execution of the processing of step S37 or step S39, the main CPU 41 ends the present subroutine.

The symbol rearrangement processing executed in step S13 in FIG. 5A has been described with reference to FIG. 6.

When the main CPU 41, the ROM 42 and the RAM 43 execute the processing of step S30 in cooperation with one another, the main CPU 41, the ROM 42 and the RAM 43 function as the controller for executing the processing (E) and the processing (F) of the present invention.

When the main CPU 41, the ROM 42 and the RAM 43 execute the processing of step S30 to step S35 in cooperation with one another, the main CPU 41, the ROM 42 and the RAM 43 function as the controller for executing the processing (D) of the present invention.

When the main CPU 41, the ROM 42 and the RAM 43 execute the processing of step S36 to step S39 in cooperation with one another, the main CPU 41, the ROM 42 and the RAM 43 function as the controller for executing the processing (A) of the present invention. Here, step S36 to step S39 correspond to the step (A) of the present invention.

When the main CPU 41, the ROM 42 and the RAM 43 execute the processing of step S31 in cooperation with one another, the main CPU 41, the ROM 42 and the RAM 43 function as the controller for executing the processing (B-2) of the present invention. Here, step S31 corresponds to the step (B-2) of the present invention.

When the main CPU 41, the ROM 42 and the RAM 43 execute the processing of step S32 in cooperation with one another, the main CPU 41, the ROM 42 and the RAM 43 function as the controller for executing the processing (B-1) of the present invention. Here, step S32 corresponds to the step (B-1) of the present invention.

After execution of the processing of step S13, the main CPU 41 determines whether or not a prize is established (step S14). Here, the establishment of a prize means a rearrangement of two or more of at least one type of the normal symbols “10”, “J”, “Q”, “K”, “UMBRELLA”, “CLOUD”, “THUNDER” and “SUN” etc. in the symbol matrix SM (see FIG. 2). In the processing, the main CPU 41 determines whether or not the normal payout amount determined in step S32 in FIG. 6 is 0.

When determining that the prize has been established, the main CPU 41 determines whether or not to have rearranged a multiplying-factor symbol in the multiplying-factor-symbol display area 101 of the symbol matrix SM based on the result of step S30 in FIG. 6 (step S15).

When determining not to have rearranged a multiplying-factor symbol, the main CPU 41 pays out coins corresponding to the normal payout amount determined in step S32 in FIG. 6 (step S16).

When determining in step S15 to have rearranged a multiplying-factor symbol, the main CPU 41 determines whether or not the rearranged multiplying-factor symbol has a predetermined color (red in the present embodiment) (step S17).

When determining that the rearranged multiplying-factor symbol has the predetermined color, the main CPU 41 pays out coins corresponding to N-fold of the normal payout amount determined in step S32 in FIG. 6 (step S18). Here, the symbol N represents a number “N” displayed on the rearranged multiplying-factor symbol.

When the main CPU 41, the ROM 42 and the RAM 43 execute the processing of step S18 in cooperation with one another, the main CPU 41, the ROM 42 and the RAM 43 function as the controller for executing the processing (C-1) of the present invention. Here, step S18 corresponds to the step (C-1) of the present invention.

Next, when determining that the multiplying-factor symbol rearranged in step S17 does not have the predetermined color, the main CPU 41 identifies normal symbols colored the same as the color of the rearranged multiplying-factor symbol, out of the rearranged normal symbols (step S19).

Next, the main CPU 41 pays out coins corresponding to the total sum (standard payout amount) of individual payout amounts for respective types of the normal symbols differently colored from that of the rearranged multiplying-factor symbol, based on the individual payout amounts for the respective types of the normal symbols determined in step S31 (step S20).

Subsequently, the main CPU 41 pays out coins corresponding to N-fold (special payout amount)of the total sum of the individual payout amounts for the respective types of the normal symbols colored the same as that of the rearranged multiplying-factor symbol (step S21). Here, the symbol N represents a number “N” displayed on the rearranged multiplying-factor symbol.

When the main CPU 41, the ROM 42 and the RAM 43 execute the processing of step S20 and step S21 in cooperation with one another, the main CPU 41, the ROM 42 and the RAM 43 function as the controller for executing the processing (C-2) of the present invention. Here, step S20 and step S21 correspond to the step (C-2) of the present invention.

When determining in step S14 that a prize is not established, or after execution of the processing of step S16, step S18 or step S21, the main CPU 41 determines whether or not a specific condition is established (step S22). In the present embodiment, the specific condition is the rearrangement of three or more normal symbols “BONUSs”. In the processing, the main CPU 41 determines whether three or more normal symbols “BONUSs” are rearranged based on the result of step S30 in FIG. 6.

When determining that the specific condition is not established, the main CPU 41 ends the present subroutine.

On the other hand, when determining that the specific condition is established, the main CPU 41 varies and displays the multiplying-factor symbols by the multiplying-factor reel 106, and then stop-displays a single multiplying-factor symbol in the multiplying-factor-symbol display area 105 (step S23). In the processing, the main CPU 41 executes a symbol selection program to determine a multiplying-factor symbol to be stop-displayed, and stop-displays the determined multiplying-factor symbol by the multiplying-factor reel 106.

Next, the main CPU 41 determines the number displayed on the stop-displayed multiplying-factor symbol as the multiplying factor for free games (step S24). In the processing, the main CPU 41 stores the determined multiplying factor for free games in a predetermined area (multiplying-factor-for-free-game storage area) of the RAM 43.

Subsequently, the main CPU 41 executes the free-game execution processing (step S25), and then ends the present subroutine.

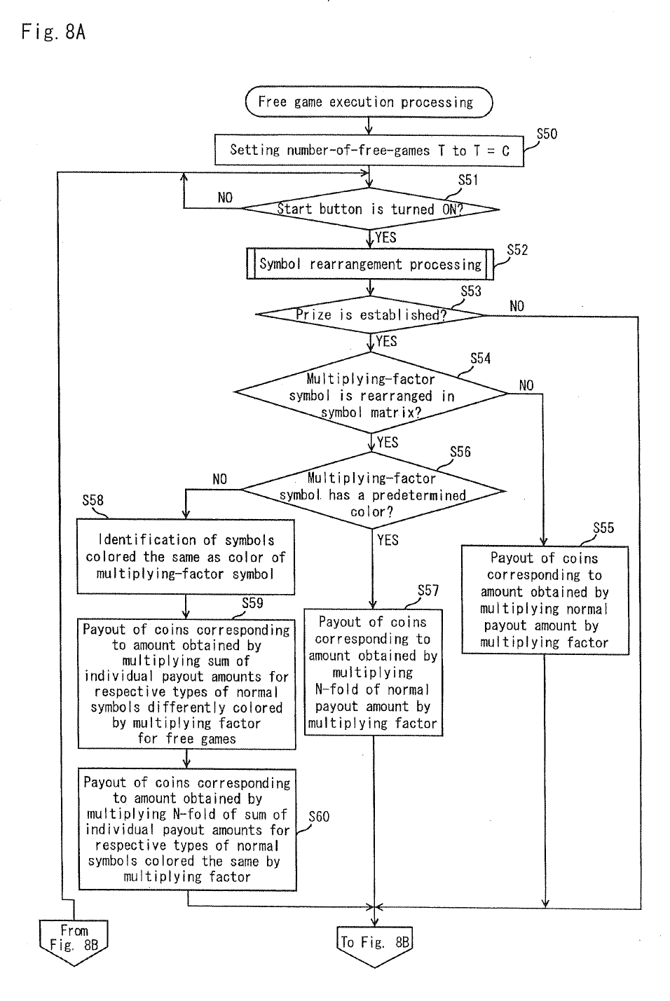

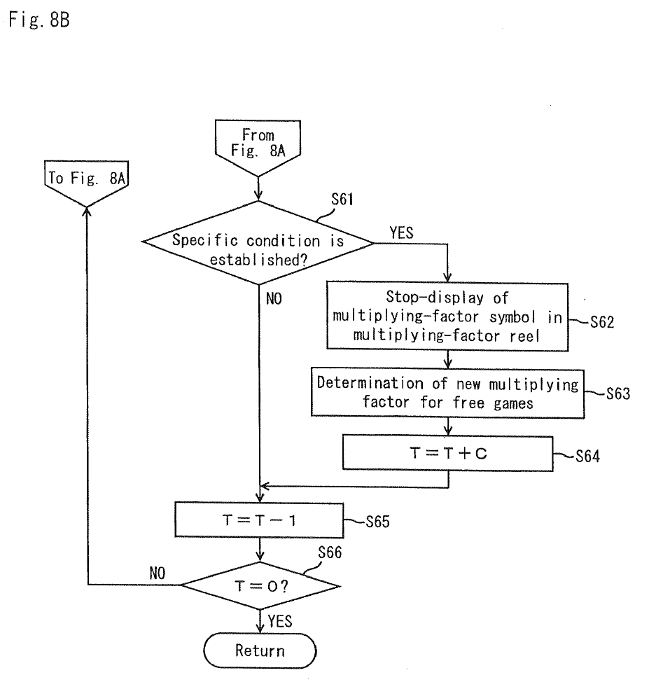

Here, the free-game execution processing will be described with reference to FIGS. 8A and 8B.

FIGS. 8A and 8B are flowcharts illustrating a subroutine of the free-game execution processing.

First, the main CPU 41 sets the number-of-remaining-free-games T to T=C (C=10, in the present embodiment) in a predetermined area (number-of-free-games storage area) of the RAM 43 (step S50).

Next, the main CPU 41 executes processing of step S51 to step S60. The processing is almost the same as the processing of step S12 to step S21 in FIG. 5A.

In FIG. 8A, only processing of step S55, step S57, step S59 and step S60 are different from those of FIG. 5A. Only the processing will be described here.

Specifically, the main CPU 41 pays out, in step S16 in FIG. 5A, coins corresponding to the normal payout amount determined in step S32 in FIG. 6. On the other hand, the main CPU 41 pays out, in step S55 in FIG. 8A, coins corresponding to an amount obtained by multiplying the normal payout amount determined in step S32 in FIG. 6 by the multiplying factor for free games.

Further, the main CPU 41 pays out, in step S18 in FIG. 5A, coins corresponding to the N-fold of the normal payout amount determined in step S32 in FIG. 6. On the other hand, the main CPU 41 pays out, in step S55 in FIG. 8A, coins corresponding to an amount obtained by multiplying the N-fold of the normal payout amount determined in step S32 in FIG. 6 by the multiplying factor for free games.

Further, the main CPU 41 pays out, in step S20 in FIG. 5A, coins corresponding to the total sum of the individual payout amounts determined in step S31 in FIG. 6 for the respective types of the normal symbols differently colored from the color of the rearranged multiplying-factor symbol, based on the individual payout amounts for the respective types of the normal symbols determined in step S31 in FIG. 6. On the other hand, the CPU 41 pays out, in step S59 in FIG. 8A, coins corresponding to an amount obtained by multiplying the individual payout amounts for the respective types of the normal symbols differently colored from the color of the rearranged multiplying-factor symbol by the multiplying factor for free games.

In addition, the main CPU 41 pays out, in step S21 in FIG. 5A, coins corresponding to the N-fold of the total sum of the individual payout amounts for the respective types of the normal symbols colored the same as the color of the rearranged multiplying-factor symbol, based on the amounts of the individual payouts for the respective types of the normal symbols determined in step S31 in FIG. 6. On the other hand, the main CPU 41 pays out, in step S60 in FIG. 8A, coins corresponding to an amount obtained by multiplying the N-fold of the total sum of the individual payout amounts for the respective types of the normal symbols colored the same as the color of the rearranged multiplying-factor symbol, by the multiplying factor for free games.

As described above, the amount of coins to be paid out in free games is N-fold larger than the amount of coins to be paid out normal games.

When determining in step S53 that a prize is not established, or after execution of the processing of step S55, step S57 or step S60, the main CPU 41 determines whether or not a specific condition is established (step S61). The specific condition is rearrangement of three normal symbols “BONUSs”, like in the normal games. In the processing, the main CPU 41 determines whether or not three or more normal symbols “BONUSs” are rearranged based on the result of step S30 in FIG. 6.

When determining that the specific condition is established, the main CPU 41 varies and displays the multiplying-factor symbols by the multiplying-factor reel 106, and then stop-displays a single multiplying-factor symbol in the multiplying-factor-symbol display area 105 (step S62).

Next, the main CPU 41 determines the number displayed on the stop-displayed multiplying-factor symbol as the new multiplying factor for free games (step S63). In the processing, the main CPU 41 overwrites and saves the determined multiplying factor for free games in the predetermined area (multiplying-factor-for-free-game storage area) in the RAM 43.

Next, the main CPU 41 sets the number-of-remaining-free-games T to T=T+C in the number-of-free-games storage area of the RAM43 (step S64). Namely, when the specific condition is established during the free games, the number of free games is increased.

When determining in step S61 that the special condition is not established or after execution of the processing of step S64, the main CPU 41 sets the number-of-remaining-free-games T to T=T−1, in the number-of-free-games storage area in the RAM 43 (step S65).

Subsequently, the main CPU 41 determines whether or not T is 0 (step S66).

When determining that T is not 0, the main CPU 41 returns the processing to step S51. On the other hand, when determining that T is 0, the main CPU 41 ends the present subroutine.

The present embodiment has been described.

In the present embodiment, there has been described the case where symbols themselves are colored. However, in the present invention, symbols may have a colored background. Also, there is no particular limitation on types and the number of colors of the symbols.

As described above, according to the slot machine 10 of the present embodiment, the multiplying-factor symbol may be rearranged in the symbol matrix SM displayed to the lower image display panel 16. Further, each of the multiplying-factor symbols corresponds to a number. In case of the rearrangement of the multiplying-factor symbol colored the predetermined color (red), the player can acquire several times larger amount of game media.

As described above, according to the slot machine 10 of the present embodiment, in case of the rearrangement of the multiplying-factor symbol colored red, the player can acquire several times larger amount of game media, resulting in enhancement of a sense of expectancy of the player for payouts. Therefore, it is possible to prevent the player from losing a sense of expectancy for payouts.

Further, since the multiplying-factor symbol capable of increasing several-fold an amount of game media that the player can acquire may be rearranged, it is possible to lead the player to have interests and concern for the rearrangement of the multiplying-factor symbol. Furthermore, since the player plays games with a great sense of expectancy for the rearrangement of the multiplying-factor symbol, it is possible to prevent the player from getting bored with games soon.

Furthermore, according to the slot machine 10 of the present embodiment, since the player can acquire a several times larger amount of game media, in case of the rearrangement of the multiplying-factor symbol colored red, it is possible to enhance interests and concern of the player for the rearrangement especially of the multiplying-factor symbol colored red out of the multiplying-factor symbols. Further, the rearrangement of the multiplying-factor symbol colored red pleases the player, while a rearrangement of a multiplying-factor symbol differently colored from the red color disappoints the player. In this way, it is possible to give the player an experience of emotional ups and downs, thereby resulting in immersion of the player in games.

Further, according to the slot machine 10 of the present embodiment, in case of the rearrangement of the multiplying-factor symbol colored blue or yellow, the player can acquire a several times larger amount of game media for the normal symbols colored the same as the color of the multiplying-factor symbol.

Therefore, the player have a lot of fun in checking which normal symbols have the same color as that of the multiplying-factor symbol, during playing games. Such an action as checking allows the player to immerse in the games.

As described above, according to the slot machine 10 of the present embodiment, the multiplying-factor symbol may be displayed only in the multiplying-factor-symbol display area 101, and is not displayed in the normal-symbol display area 100 of the symbol matrix SM.

Therefore, it is possible to lead the player expecting for the rearrangement of the multiplying-factor symbol to concentrate on the multiplying-factor-symbol display area 101, resulting in immersion of the player in the game.

Further, according to the slot machine 10 of the present embodiment, a single multiplying-factor symbol is stop-displayed after the multiplying-factor symbols are varied and displayed by the multiplying-factor reel 106. Each of the multiplying-factor symbols has a number displayed thereon. The player can acquire a several times larger amount of game media, based on the number displayed on the stop-displayed multiplying-factor symbol, resulting in enhancement of a sense of expectancy of the player for payouts. Therefore, it is possible to prevent the player from losing a sense of expectancy for payouts.

Further, since the multiplying-factor symbol capable of increasing several-fold an amount of game media that the player can acquire is stop-displayed, it is possible to lead the player to have interests and concern for the number displayed on the multiplying-factor symbol to be stop-displayed. Furthermore, since the player plays games with a great sense of expectancy for stop-display of a multiplying-factor symbol having a large number displayed thereon, it is possible to prevent the player from getting bored with games soon.

Further, according to the slot machine of the present embodiment, the player can acquire a several times larger amount of game media, on condition that rearranged normal symbols or a combination thereof satisfies the specific condition (rearrangement of three or more symbol “BONUSs”).

Accordingly, the player has a lot of interests in whether or not the specific condition is established, and this configuration can lead the player to have a lot of interests in whether or not the specific condition is established as well as which prize is established by rearranged symbols. Therefore, it is possible to enhance interests of the player in symbols to be rearranged and also to immerse the player in the games.

Further, according to the slot machine of the present embodiment, free games are conducted in the event of the establishment of the specific condition. During the free games, the player can acquire a several times larger amount of game media than the amount of game media that the player can acquire in the normal games.

Therefore, since the player can play game without BETTING game media and also acquire a several times larger amount of a payout, it is possible to further enhance interest and concern of the player for the specific condition that generates free games. As a result, this configuration can immerse the player in the games.

Further, according to the slot machine of the present embodiment, when a multiplying-factor symbol is rearranged in the symbol matrix in the free games, the player is offered a payout in amount obtained by multiplying both of the multiplying factor set for the multiplying-factor symbol and the multiplying factor for free games. Accordingly, since the payout amount is significantly increased in this case, it is possible to significantly enhance a sense of expectation of the player for the establishment of the specific condition and the rearrangement of a multiplying-factor symbol in the symbol matrix SM during the free games.

Further, according to the slot machine of the present embodiment, the pattern of the rearrangements is determined based on the normal payout amount. Specifically, when the normal payout amount is equal to or less than the predetermined amount, the multiplying-factor symbol is rearranged in the symbol matrix SM at the end. Therefore, it is possible to please a player who is disappointed at establishment of only a prize that offers a small amount of a payout, by rearranging a multiplying-factor symbol having a large multiplying factor set therefor at the end.

Further, according to the slot machine of the present embodiment, the pattern of the rearrangement of the symbols is determined, based on the selection of the player, out of the following patterns: a pattern in which the multiplying-factor symbol is rearranged after rearranging the normal symbols; and a pattern in which the normal symbols are rearranged after rearranging the multiplying-factor symbol. Accordingly, this configuration allows the player to set the timing of the rearrangement of the multiplying-factor symbol as he/she likes, leading to giving satisfaction to the player. Further, this configuration also allows to the player to change the timing of the rearrangement of the multiplying-factor symbol at any time during a game, leading to prevention of the player from getting bored.

In the embodiment described above, there have been described the cases where symbols are rearranged in the symbol matrix SM of the lower image display panel 16 (the slot machine 10 is a so-called a video slot machine). However, the slot machine according to the present invention may be configured to rearrange symbols using so-called mechanical reels.

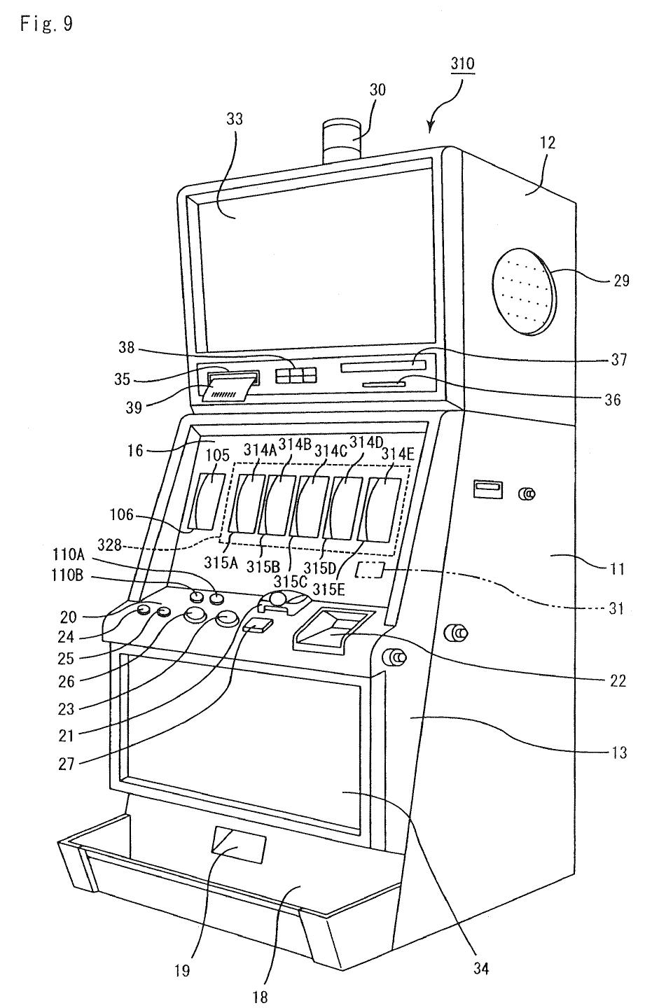

FIG. 9 is a perspective view illustrating the general appearance of a slot machine according to another embodiment.

In the following description, the components corresponding to those of the slot machine 10 will be designated by the same reference numerals.

Further, the slot machine 310 has substantially the same external appearance, the same circuit structure and the like as those of the slot machine 10 and also executes substantially the same flowcharts as those executed by the slot machine 10, except that it employs mechanical reels, and, therefore, only the mechanical reels will be described herein.

As illustrated in FIG. 9, 5 reels 314 (314A, 314B, 314C, 314D and 314E) are rotatably provided within a cabinet 11. On the outer peripheral surfaces of the reels 314A, 314B, 314C, 314D and 314E, there are drawn symbol sequences constituted by normal symbols such as “10”, “J”, “Q”, “K”, “UMBRELLA”, “CLOUD”, “THUNDER”, “SUN” and “BONUS”, and multiplying-factor symbols.

At the center portion of the lower image display panel 16, there is provided a display area 328 for displaying the symbols. Within the display area 328, there are formed five display windows 315 (315A, 315B, 315C, 315D and 315E) visible through their back surfaces. Further, the symbols drawn on the outer peripheral surfaces of the reels 314A, 314B, 314C, 314D and 314E are displayed on a three-by-three basis, through the display windows 315A, 315B, 315C, 315D and 315E.

Although the present invention has been described with reference to embodiments thereof, these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processing described in the present specification are to be executed by various types of devices, in principle. Further, other structures required for conducting each step will be apparent from the aforementioned description.

What is claimed as new and desired to be secured by Letters Patent of the United States:

1. A slot machine comprising:
a display capable of rearranging normal symbols and a multiplying-factor symbol corresponding to a number; and
a controller programmed to execute processing of:
(A) rearranging said normal symbols and said multiplying-factor symbol to said display in such a manner that said multiplying-factor symbol is rearranged at a timing of a first or last rearrangement in rearrangements, when said multiplying-factor symbol is rearranged to said display;
(B-1) determining a normal payout amount, based on the numbers of said normal symbols of respective types rearranged in said processing (A); and
(C-1) paying out game media in amount obtained by multiplying the normal payout amount determined in said processing (B-1) by the number corresponding to said multiplying-factor symbol rearranged in said processing (A).

2. The slot machine according to claim 1,
wherein
said controller is further programmed to execute processing of:
(D) determining either one of the first rearrangement or the last rearrangement as the timing of the rearrangement of said multiplying-factor symbol in said processing (A), and
said processing (A) is processing for rearranging said multiplying-factor symbol to said display at the timing determined in said processing (D).

3. The slot machine according to claim 2,
wherein
said controller is further programmed to execute processing of:
(E) determining types of normal symbols to be rearranged to said display, before said processing (A), and
said processing (D) is processing for determining either one of the first rearrangement or the last rearrangement as the timing of the rearrangement of said multiplying-factor symbol in said processing (A), based on the types of the normal symbols determined in said processing (E).

4. The slot machine according to claim 2,
wherein
said controller is further programmed to execute processing of:
(F) determining the numbers of the normal symbols of the respective types to be rearranged to said display, before said processing (A), and
said processing (D) is processing for determining either one of the first rearrangement or the last rearrangement as the timing of the rearrangement of said multiplying-factor symbol in said processing (A), based on the numbers of the normal symbols of the respective types determined in said processing (B).

5. The slot machine according to claim 2, comprising:
an input device enabling a player to input commands associated with games,
wherein
said controller is further programmed to execute processing of:
(G) accepting from said input device an input of selection of either one of the first rearrangement or the last rearrangement as the timing of the rearrangement of the multiplying-factor symbol in said processing (A), and
said processing (D) is processing for determining either one of the first rearrangement or the last rearrangement as the timing of the rearrangement of said multiplying-factor symbol in said processing (A), based on the input inputted through the input device in said processing (G).

6. A slot machine comprising:
a display capable of rearranging normal symbols and a multiplying-factor symbol corresponding to a number; and
a controller programmed to execute processing of:
(A) rearranging said normal symbols and said multiplying-factor symbol to said display in such a manner that said multiplying-factor symbol is rearranged at a timing of a first or last rearrangement in rearrangements, when said multiplying-factor symbol is rearranged to said display;
(B-2) determining, based on the numbers of the normal symbols of respective types rearranged in said processing (A), individual payout amounts for said respective types; and
(C-2) paying out a special amount of game media and a standard amount of game media, the special payout amount being obtained by multiplying an amount obtained by summing said individual payout amounts for types satisfying a predetermined condition by said number corresponding to said multiplying-factor symbol rearranged in said processing (A), the standard payout amount being obtained by summing said individual payout amounts for types failing to satisfy the predetermined condition.

7. The slot machine according to claim 6,
wherein
said controller is further programmed to execute processing of:
(D) determining either one of the first rearrangement or the last rearrangement as the timing of the rearrangement of said multiplying-factor symbol in said processing of (A), and
said processing (A) is processing for rearranging said multiplying-factor symbol to said display at the timing determined in said processing (D).

8. The slot machine according to claim 7,
wherein
said controller is further programmed to execute processing of:
(E) determining types of normal symbols to be rearranged to said display, before said processing (A), and
said processing (D) is processing for determining either one of the first rearrangement or the last rearrangement as the timing of the rearrangement of said multiplying-factor symbol in said processing (A), based on the types of the normal symbols determined in said processing (E).

9. The slot machine according to claim 7,
wherein
said controller is further programmed to execute processing of:
(F) determining the numbers of the normal symbols of the respective types to be rearranged to said display, before said processing (A), and
said processing (D) is processing for determining either one of the first rearrangement or the last rearrangement as the timing of the rearrangement of said multiplying-factor symbol in said processing (A), based on the numbers of the normal symbols of the respective types determined in said processing (F).

10. The slot machine according to claim 7, comprising:
an input device enabling a player to input commands associated with games,
wherein
said controller is further programmed to execute processing of:
(G) accepting from said input device an input for selecting either one the first rearrangement or the last rearrangement as the timing of the rearrangement of the multiplying-factor symbol in said processing (A), and
said processing (D) is processing for determining either one of the first rearrangement or the last rearrangement as the timing of the rearrangement of said multiplying-factor symbol in said processing (A), based on the input inputted by the input device in said processing (G).

11. A controlling method of a slot machine comprising steps of:
(A) rearranging normal symbols and a multiplying-factor symbol corresponding to a number to display in such a manner that said multiplying-factor symbol is rearranged at a timing of a first or last rearrangement in rearrangements, when said multiplying-factor symbol is rearranged to said display;
(B-1) determining a normal payout amount, based on the numbers of said normal symbols of respective types rearranged in said step (A); and
(C-1) paying out game media in amount obtained by multiplying the normal payout amount determined in said step (B-1) by the number corresponding to said multiplying-factor symbol rearranged in said step (A).

12. A controlling method of a slot machine comprising steps of:
(A) rearranging normal symbols and a multiplying-factor symbol to display in such a manner that said multiplying-factor symbol is rearranged at a timing of a first or last rearrangement in rearrangements, when said multiplying-factor symbol is rearranged to said display;
(B-2) determining, based on the numbers of the normal symbols of respective types rearranged in said step (A), individual payout amounts for said respective types; and
(C-2) paying out a special amount of game media and a standard amount of game media, the special payout amount being obtained by multiplying an amount obtained by summing said individual payout amounts for types satisfying a predetermined condition by said number corresponding to said multiplying-factor symbol rearranged in said step (A), the standard payout amount being obtained by summing said individual payout amounts for types failing to satisfy the predetermined condition.
